(19) United States
(12) Patent Application Publication
(10) Pub. No.: US 2019/0108789 A1
(43) Pub. Date: Apr. 11, 2019

(54) DISPLAY DEVICE

(71) Applicant: JOLED INC., Tokyo (JP)

(72) Inventor: Hitoshi TSUGE, Tokyo (JP)

(73) Assignee: JOLED INC., Tokyo (JP)

(21) Appl. No.: 16/046,319

(22) Filed: Jul. 26, 2018

(30) Foreign Application Priority Data
Oct. 5, 2017 (JP) 2017-194936

(51) Int. Cl. G09G 3/3233

(52) U.S. Cl. CPC G09G 3/3233; G09G 2300/0413; G09G 2320/0233

(57) ABSTRACT

A display device includes a display panel and a control circuit which controls the display panel. The display panel includes pixel circuits and one or more dummy pixel circuits. Each pixel circuit includes an organic EL element having a first electrode and a second electrode, and a drive transistor. Each dummy pixel circuit includes a dummy capacitance element having a first dummy electrode, and a second dummy electrode shared with the second electrode of the organic EL element. The control circuit performs at least one of initialization control to initialize a potential of the first electrode in a different pixel circuit and dummy initialization control to initialize a potential of the first dummy electrode in the dummy pixel circuit within a period for which threshold compensation control to compensate for a threshold voltage of the drive transistor is performed on each of the pixel circuits.

### CROSS REFERENCE TO RELATED APPLICATIONS

The present application is based on and claims priority of Japanese Patent Application No. 2017-194936 filed on Oct. 5, 2017. The entire disclosure of the above-identified application, including the specification, drawings and claims is incorporated herein by reference in its entirety.

### FIELD

The present disclosure relates to display devices including organic electroluminescent (EL) elements.

### BACKGROUND

Display devices including organic EL elements have been conventionally developed. Such a display device includes pixel circuits arranged into a matrix. Each of the pixel circuits includes an organic EL element and a drive transistor which feeds current to the organic EL element according to the video signal input to the display device. With use of the display device, the drive transistor is degraded, and the threshold voltage is shifted. When such a shift in the threshold voltage of the drive transistor occurs, the current corresponding to the video signal cannot be fed to the organic EL element. For this reason, the organic EL element cannot emit light having a luminance corresponding to the video signal. To solve such problems, techniques for compensating for the threshold voltage have been proposed (Patent Literature 1).

In the display device disclosed in Patent Literature 1, the threshold voltage is compensated by applying the voltage equivalent to a threshold voltage between the gate electrode of a drive transistor and the source electrode thereof before application of the voltage corresponding to a video signal between the gate electrode of the drive transistor and the source electrode thereof. Through such compensation, the current corresponding to the video signal is fed to the organic EL element.

### CITATION LIST

### Patent Literature

Patent Literature 1: WO2015/033496

### SUMMARY

### Technical Problem

Unfortunately, uneven luminance may be generated in the display device disclosed in Patent Literature 1.

The present disclosure has been made in consideration of the problems described above. An object of the present disclosure is to provide a display device including organic EL elements while the uneven luminance of the display device is reduced.

### Solution to Problem

To achieve the object above, the display device according to one aspect of the present disclosure includes a display panel, and a control circuit which controls the display panel. The display panel includes a plurality of pixel circuits arranged into a matrix in a display region of the display panel, and one or more dummy pixel circuits disposed external to the display region. Each of the pixel circuits includes an organic EL element having a first electrode and a second electrode, a capacitance element which retains voltage, and a drive transistor which is connected to the first electrode of the organic EL element and feeds a current corresponding to the voltage retained in the capacitance element to the organic EL element. Each of the one or more dummy pixel circuits includes a dummy capacitance element having a first dummy electrode, and a second dummy electrode shared with the second electrode of the organic EL element. The control circuit performs at least one of initialization controls within a period for which threshold compensation control to compensate for a threshold voltage of the drive transistor is performed on each of the pixel circuits, the initialization controls being initialization control to initialize a potential of the first electrode of the organic EL element in at least one different pixel circuit among the pixel circuits and dummy initialization control to initialize the potential of the first dummy electrode of the dummy capacitance element.

### Advantageous Effects

The present disclosure can reduce uneven luminance in a display device including organic EL elements.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a block diagram illustrating a functional configuration of a display device in a related art.

FIG. 2 is a circuit diagram illustrating one example of a pixel circuit of the display device in the related art.

FIG. 3 is a schematic view illustrating uneven luminance generated in a display unit in the related art.

FIG. 4 is a timing chart illustrating waveforms of signals input to control signal lines and a data signal line in the display device.

FIG. 5 is a circuit diagram illustrating a first phenomenon which occurs in the display device in the related art.

FIG. 6 is a circuit diagram illustrating a second phenomenon which occurs in the display device in the related art.

FIG. 7 is a graph illustrating an outline of the voltage-current density properties of a contact resistor 25 disposed between a second electrode of an organic EL element 24 and a cathode power supply line VCAT in a pixel circuit 90.

FIG. 8 is a schematic sectional view illustrating one example of a contact region in which contact resistance 25 is generated.

FIG. 9 is a schematic sectional view illustrating another example of a contact region in which contact resistance is generated.

FIG. 10 is a graph illustrating a voltage waveform of a second electrode in a pixel circuit during one frame period of the display device in the related art.

FIG. 11A is a schematic view illustrating positions in a display unit at a point of time t=ta in the display device in the related art, the positions corresponding to the row containing the pixel circuit subjected to threshold compensation control and the row containing the pixel circuit subjected to initialization control, respectively.

FIG. 11B is a schematic view illustrating positions in a display unit at a point of time t=tb in the display device in the related art, the positions corresponding to the row containing the pixel circuit subjected to threshold compensation control and the row containing the pixel circuit subjected to initialization control, respectively.

FIG. 11C is a schematic view illustrating positions in a display unit at a point of time t=tc in the display device in the related art, the positions corresponding to the row containing the pixel circuit subjected to threshold compensation control and the row containing the pixel circuit subjected to initialization control, respectively.

FIG. 11D is a schematic view illustrating a position in a display unit at a point of time t=td in the display device in the related art, the position corresponding to the row containing the pixel circuit subjected to threshold compensation control.

FIG. 12 is a block diagram illustrating a functional configuration of a display device according to Embodiment 1.

FIG. 13 is a circuit diagram illustrating one example of a dummy pixel circuit of the display device according to Embodiment 1.

FIG. 14 is a schematic plan view of a display panel illustrating an arrangement of a dummy region according to Modification 1 of Embodiment 1.

FIG. 15 is a schematic plan view of a display panel illustrating an arrangement of a dummy region according to Modification 2 of Embodiment 1.

FIG. 16 is a schematic plan view of a display panel illustrating an arrangement of a dummy region according to Modification 3 of Embodiment 1.

FIG. 17 is a schematic plan view of a display panel illustrating an arrangement of a dummy region according to Modification 4 of Embodiment 1.

FIG. 18 is a schematic plan view of a display panel illustrating an arrangement of a dummy region according to Modification 5 of Embodiment 1.

FIG. 19 is a schematic plan view of a display panel illustrating an arrangement of a dummy region according to Modification 6 of Embodiment 1.

FIG. 20 is a schematic plan view of a display panel illustrating an arrangement of a dummy region Pd according to Modification 7 of Embodiment 1.

FIG. 21 is a circuit diagram illustrating a circuit configuration of a dummy pixel circuit according to Modification 8 of Embodiment 1.

FIG. 22 is a circuit diagram illustrating a circuit configuration of a dummy pixel circuit according to Modification 9 of Embodiment 1.

FIG. 23 is a circuit diagram illustrating a circuit configuration of a dummy pixel circuit according to Modification 10 of Embodiment 1.

FIG. 24A is a schematic graph illustrating waveforms of potentials of initialization power supply lines in rows of the display device according to Embodiment 1.

FIG. 24B is a schematic graph illustrating waveforms of potentials of initialization power supply lines in rows of a display device according to Embodiment 2.

FIG. 25 is a schematic wiring diagram illustrating a configuration of the initialization power supply line according to Embodiment 2.

FIG. 26 is a graph illustrating a waveform of a potential of a gate electrode of a drive transistor in the pixel circuit according to Embodiment 1.

FIG. 27 is a diagram illustrating a wiring layout of a pixel circuit according to Embodiment 3.

FIG. 28 is a schematic view illustrating an outline of a shape of an electrode of a reference transistor according to Embodiment 3.

FIG. 29 is a schematic view illustrating an outline of another shape of the electrode of the reference transistor according to Embodiment 3.

### DESCRIPTION OF EMBODIMENTS

### (Knowledge Based on the Present Disclosure)

Prior to the description of embodiments according to the present disclosure, the knowledge based on the present disclosure will be described. As the knowledge based on the present disclosure, a display device in a related art and its problems will now be described.

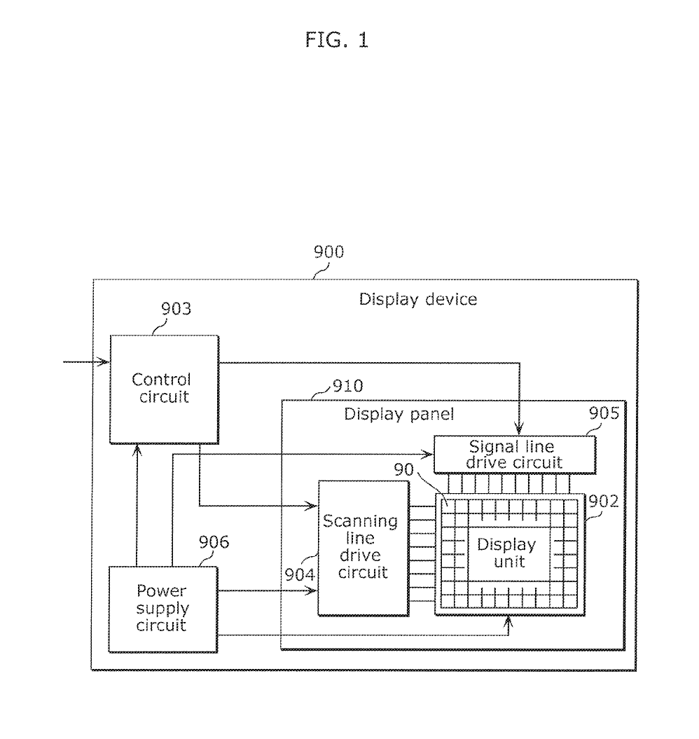

FIG. 1 is a block diagram illustrating a functional configuration of a display device 900 in a related art. The display device 900 in the related art illustrated in FIG. 1 mainly includes a display panel 910, a control circuit 903, and a power supply circuit 906.

The display panel 910 includes a display unit 902, a scanning line drive circuit 904, and a signal line drive circuit 905.

The display unit 902 includes pixel circuits 90 arranged into a matrix. The rows of the matrix include control signal lines, and the control signal lines in each row are disposed to be commonly connected to the pixel circuits 90 arranged in the row. The columns of the matrix include data signal lines, and the data signal line in each column is disposed to be commonly connected to the pixel circuits 90 arranged in the column.

The scanning line drive circuit 904 feeds control signals for controlling the operation of pixel circuits 90 through the control signal lines to the pixel circuits 90.

The signal line drive circuit 905 feeds data signals corresponding to the luminance of emitted light through the data signal lines to the pixel circuits 90. The data signals are voltage signals based on the gradation of display in the pixel circuits 90.

The control circuit 903 controls the display panel 910. This circuit receives an external video signal, and controls the scanning line drive circuit 904 and the signal line drive circuit 905 such that the image expressed by the video signal is displayed on the display unit 902.

The power supply circuit 906 feeds power supply for operating the display device 900 to the components of the display device 900.

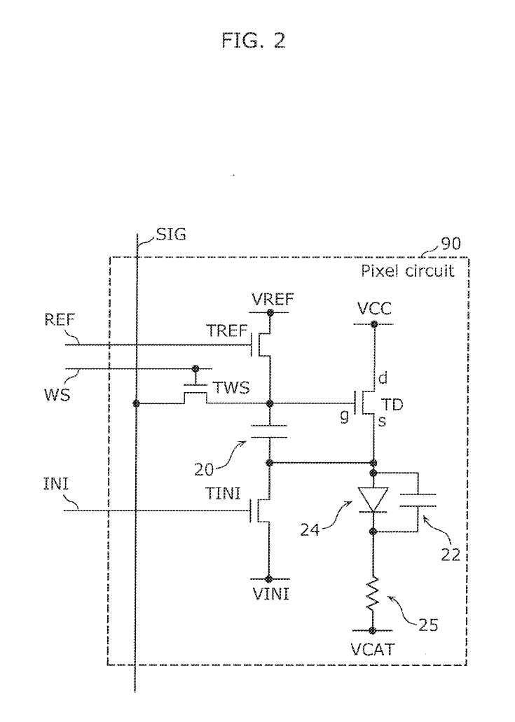

The pixel circuits 90 will be described with reference to a drawing. FIG. 2 is a circuit diagram illustrating one example of a pixel circuit 90 in the display device 900 in the related art. The pixel circuits 90 cause organic EL elements 24 to emit light beams having the luminances according to the data signals. As illustrated in FIG. 2, each of the pixel circuits 90 includes an organic EL element 24, a capacitance element 20, and a drive transistor TD. Each of the pixel circuits 90 further includes a reference transistor TREF, a writing transistor TWS, and an initialization transistor TINI. Each of the pixel circuits 90 is connected to a reference signal line REF, a writing signal line WS, and an initialization signal line INI which feed control signals output from the scanning line drive circuit 904. Each of the pixel circuits 90 is connected to a data signal line SIG which feeds a data signal output from the signal line drive circuit 905.

The organic EL element 24 is a light-emitting element having a first electrode and a second electrode. In the example illustrated in FIG. 2, the first electrode and the second electrode are the anode and the cathode of the organic EL element 24, respectively. Because the organic EL element 24 has a capacitance component, the equivalent circuit of the pixel circuit 90 is expressed as in FIG. 2 using an EL capacitance element 22 corresponding to the capacitance component of the organic EL element 24. The second electrode of the organic EL element 24 is connected to a cathode power supply line VCAT. Note that a contact resistor 25 is present between the second electrode and the cathode power supply line VCAT.

The capacitance element 20 retains voltage, and is connected between the gate electrode g of a drive transistor TD and the source electrode s thereof.

The drive transistor TD is a thin film transistor which is connected to the first electrode of the organic EL element 24, and feeds a current corresponding to the voltage retained in the capacitance element 20 to the organic EL element 24. The source electrode s of the drive transistor TD is connected to the first electrode (anode) of the organic EL element 24, and the drain electrode d thereof is connected to the anode power supply line VCC.

The initialization transistor TINI is a thin film transistor for initializing the potential of the first electrode of the organic EL element 24. One of the drain electrode and the source electrode of the initialization transistor TINI is connected to an initialization power supply line VINI, and the other is connected to the first electrode (anode) of the organic EL element 24. The initialization transistor TINI has a gate electrode connected to an initialization signal line INI.

The reference transistor TREF is a thin film transistor for applying a reference voltage to capacitance element 20. One of the drain electrode and the source electrode of the reference transistor TREF is connected to a reference power supply line VREF, and the other is connected to the gate electrode g of the drive transistor TD. The reference transistor TREF has a gate electrode connected to a reference signal line REF.

The writing transistor TWS is a thin film transistor for applying a voltage corresponding to the data signal to the capacitance element 20. One of the drain electrode and the source electrode of the writing transistor TWS is connected to a data signal line SIG, and the other is connected to the gate electrode of the drive transistor TD. The writing transistor TWS has a gate electrode connected to a writing signal line WS.

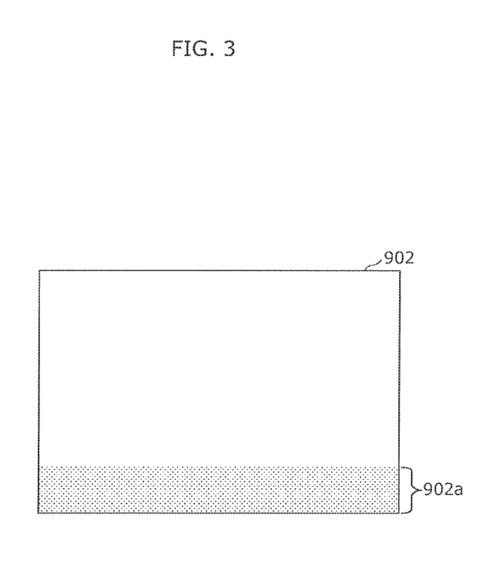

The present inventor has found that uneven luminance is generated in the display device 900 in the related art as described above. Such uneven luminance generated in the display device 900 will now be described with reference to a drawing. FIG. 3 is a schematic view illustrating uneven luminance generated in the display unit 902 in the related art.

As illustrated in FIG. 3, a region 902a having a luminance lower than that of another region is generated in a lower portion of the display unit 902 of the display device 900. Hereinafter, the region 902a is also referred to as “uneven luminance occurring region.” One of the causes to generate such uneven luminance will now be described with reference to the drawings.

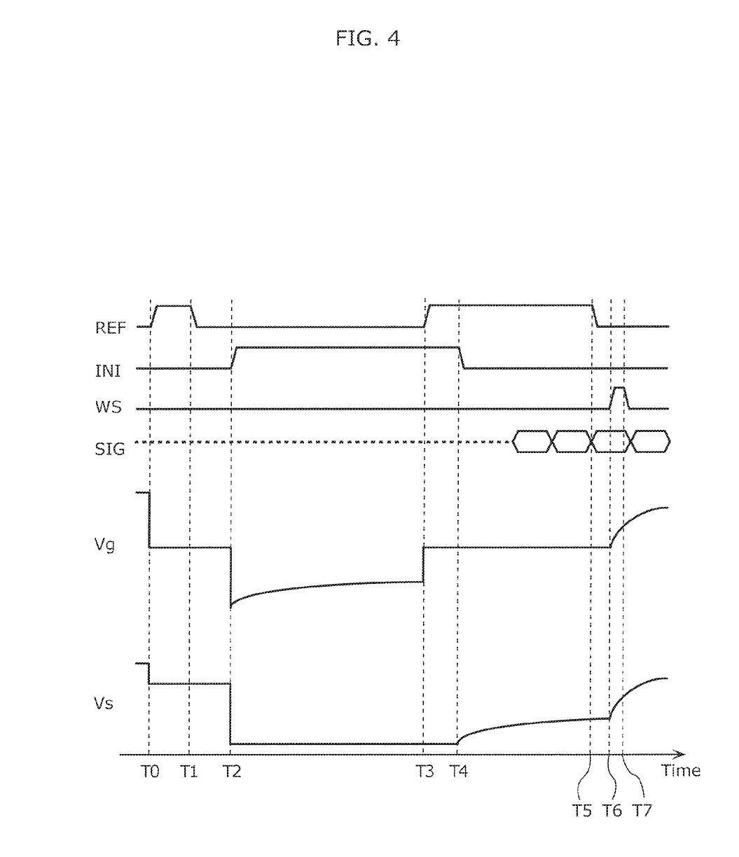

FIG. 4 is a timing chart illustrating waveforms of signals input into the control signal lines and the data signal line SIG in the display device 900. FIG. 4 illustrates the waveforms of these signals during one frame period, as well as the waveforms of the potential Vg of gate electrode g and the potential Vs of the source electrode s of the drive transistor TD. A data signal corresponding to each row is applied to the data signal line SIG during each period of one horizontal scan. As illustrated in FIG. 4, first, at the point of time T0, the reference signal output to the reference signal line REF becomes high, and the drain electrode of the reference transistor TREF is electrically conducted to the source electrode thereof. As a result, a reference voltage of about 1 V, for example, is applied to the gate electrode g of the drive transistor TD. The reference signal input to the reference signal line REF becomes low at the point of time T1, and the drain electrode of the reference transistor TREF is not electrically conducted to the source electrode thereof. The period from the point of time T0 to the point of time T1 is a non-light emitting period for controlling the organic EL element 24 to a non-light emitting state.

Subsequently, the initialization signal input to the initialization signal line INI becomes high at the point of time T2. As a result, the drain electrode of the initialization transistor TINI is electrically conducted to the source electrode thereof. Accordingly, the potential of an electrode connected to the first electrode of the organic EL element 24, the source electrode s of the drive transistor TD, and the first electrode of the capacitance element 20 is initialized. In the example illustrated in FIG. 2, for example, an initialization voltage of about −3 V is applied to the first electrode of the organic EL element 24.

Subsequently, at the point of time T3, the reference signal input into the reference signal line REF becomes high, and the reference voltage is applied to the electrode connected to the gate electrode g of the drive transistor TD as in the operation at the point of time T0. As a result, a reference voltage of about 1 V is applied to the gate electrode g of the drive transistor TD, and an initialization voltage of about −3 V is applied to the source electrode s. In other words, a voltage of about 4 V is applied between the gate electrode g of the drive transistor TD and the source electrode s thereof and to the capacitance element 20. Here, a drive transistor TD having a threshold voltage of less than 4 V is used. In this case, a current corresponding to the voltage retained in the capacitance element 20 flows between the drain electrode d of the drive transistor TD and the source electrode s thereof. At this time, an initialization voltage of about −3 V is applied to the anode of the organic EL element 24 via the initialization transistor TINI, and a cathode voltage of about +1.5 V is applied to the cathode thereof by the cathode power supply line VCAT. In other words, a reverse bias is applied to the organic EL element 24, and therefore the organic EL element 24 does not emit light. The current flowing through the drive transistor TD flows into the capacitance element 20, and is used in the threshold compensation operation described later. Hereinafter, the control to initialize the potential of the first electrode of the organic EL element 24 from the point of time T2 to the point of time T4 described later is referred to as initialization control.

Subsequently, at the point of time T4, the initialization signal input into the initialization signal line INI becomes low, and the drain electrode of the initialization transistor TINI is not electrically conducted to the source electrode thereof. As a result, at the point of time T4 and thereafter, the feed of the voltage from the initialization power supply line VINI to the capacitance element 20 is blocked, and a reverse bias is applied to the organic EL element 24. For this reason, the current flowing between the gate electrode g of the drive transistor TD and the source electrode s thereof flows into the capacitance element 20. Accompanied by this operation, the potential of the electrode of the capacitance element 20 connected to the source electrode s of the drive transistor TD gradually increases. The voltage between the gate electrode g of the drive transistor TD and the source electrode s thereof, i.e., the voltage retained in the capacitance element 20 gradually reduces. When the voltage retained in the capacitance element 20 becomes close to the threshold voltage of the drive transistor TD, the current no longer flows between the gate electrode g of the drive transistor TD and the source electrode s thereof. As described above, the voltage retained in the capacitance element 20 is kept equal to the threshold voltage of the drive transistor TD. At this time, the value of the cathode voltage applied to the cathode power supply line VCAT is set such that a voltage equal to or exceeding the forward threshold voltage is not applied to the organic EL element 24 even when the potential of the source electrode s of the drive transistor TD increases. As described above, the display device 900 compensates for the threshold voltage of drive transistor TD. Subsequently, at the point of time T5, the reference signal input to the reference signal line REF becomes low, and the drain electrode of the reference transistor TREF is not electrically conducted to the source electrode thereof. Hereinafter, the control to compensate for the threshold voltage of the drive transistor TD from the point of time T4 to the point of time T5 is referred to as threshold compensation control.

Subsequently, at the point of time T6, the signal input into the writing signal line WS becomes high, and the drain electrode of the writing transistor TWS is electrically conducted to the source electrode thereof. Accompanied by this, a voltage corresponding to the data signal input to the data signal line SIG is applied to the capacitance element 20. Specifically, the voltage Vgs applied to the capacitance element 20 is represented by the following equation using the voltage Vsig of the data signal, the reference voltage Vref, the threshold voltage Vth of the drive transistor TD, the capacitance Cs of the capacitance element 20, and the capacitance Coled of the EL capacitance element 22:

Vgs=(Vsig−Vref)×Coled/(Cs+Coled)+Vth

Subsequently, at the point of time T7, the signal input to the writing signal line WS becomes low, and the drain electrode of the writing transistor TWS is not electrically conducted to the source electrode thereof. Accompanied by this, the application of the data signal to the gate electrode g of the drive transistor TD is cancelled. For this reason, an increase in potential Vg of the gate electrode g of the drive transistor TD is enabled, and an increase in potential Vs of the source electrode s is also enabled. At this time, the bootstrapping operation is started in the drive transistor TD in response to the flow of the drain current and the charge of the EL capacitance element 22. That is, the potential Vs of the anode of the organic EL element 24, i.e., the source electrode s of the drive transistor TD increases, and thus the potential Vg of the gate electrode g of the drive transistor TD also increases. The reverse bias of the organic EL element 24 is cancelled in this bootstrapping operation, which increases the potential Vs of the source electrode s of the drive transistor TD. As a result, the output current of the drive transistor TD flows into the organic EL element 24. Thereby, the organic EL element 24 emits light having a luminance according to the gradation of display represented by the data signal.

Each of the pixel circuits 90 sequentially performs the above-described operation in the display unit 902 of the display device 900.

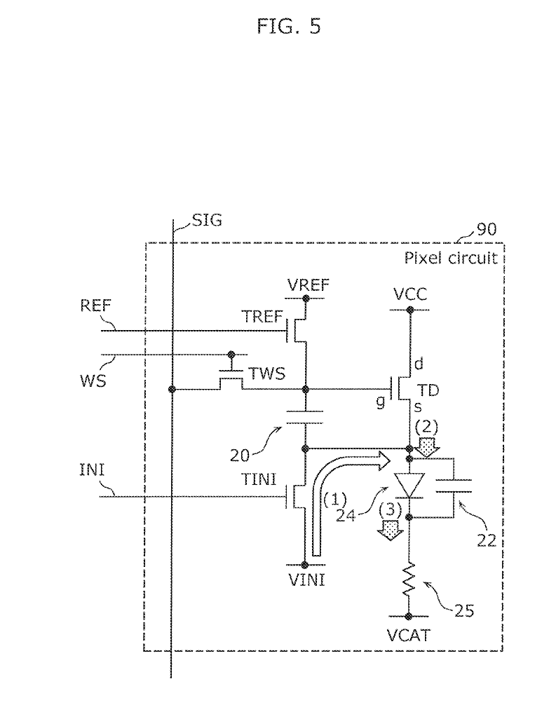

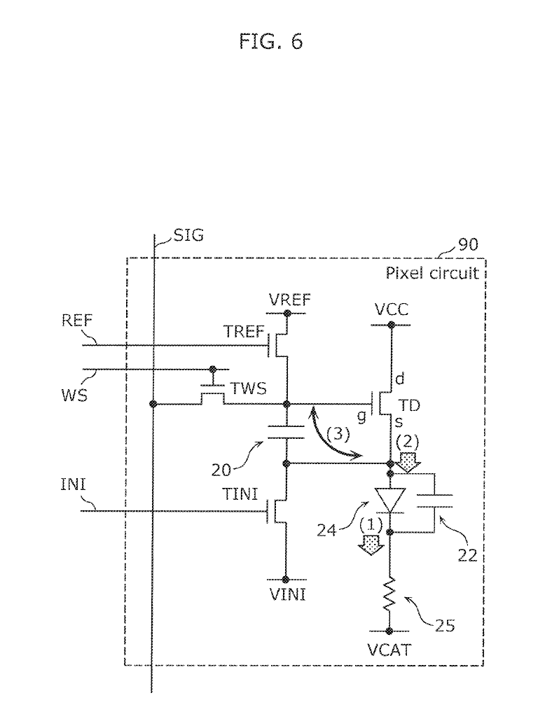

The phenomena occurring when the pixel circuits 90 sequentially perform this operation will now be described with reference to the drawings. FIGS. 5 and 6 are circuit diagrams illustrating first and second phenomena occurring in the display device 900 in the related art.

At the point of time T2 in FIG. 4, a reference voltage of about 1 V is being applied to the first electrode immediately before an initialization voltage of about −3 V is applied to the first electrode (anode) of the organic EL element 24. At the point of time T2, the initialization voltage is applied to the first electrode as indicated by the arrow (1) in FIG. 5. Accompanied by this, the potential of the first electrode rapidly reduces from about 1 V to about −3 V (see the arrow (2) in FIG. 5). Here, the EL capacitance element 22 is present between the first electrode and the second electrode as described above. The contact resistor 25 is present between the second electrode and the cathode power supply line VCAT. For these reasons, the potential of the second electrode may vary. In particular, in the case where the current flowing from the second electrode to the cathode power supply line VCAT has small density, the resistance value of the contact resistor 25 increases, remarkably varying the potential of the second electrode. For this reason, accompanied by the reduction in potential of the first electrode, the potential of the second electrode also reduces (see the arrow (3) in FIG. 5).

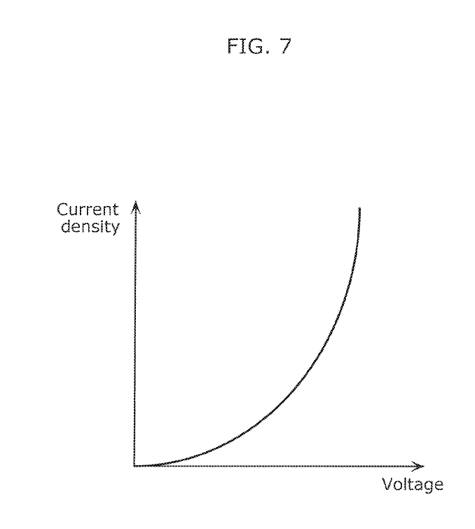

Here, the non-linearity of the resistance value of the contact resistor 25 will be described with reference to a drawing. FIG. 7 is a graph illustrating an outline of the voltage-current density properties of the contact resistor 25 disposed between the second electrode of the organic EL element 24 and the cathode power supply line VCAT in the pixel circuit 90. As illustrated in FIG. 7, the contact resistor 25 has non-linear voltage-current density properties. In other words, the resistance value of the contact resistor 25 varies according to the current density. The resistance value of the contact resistor 25 increases at a smaller current density.

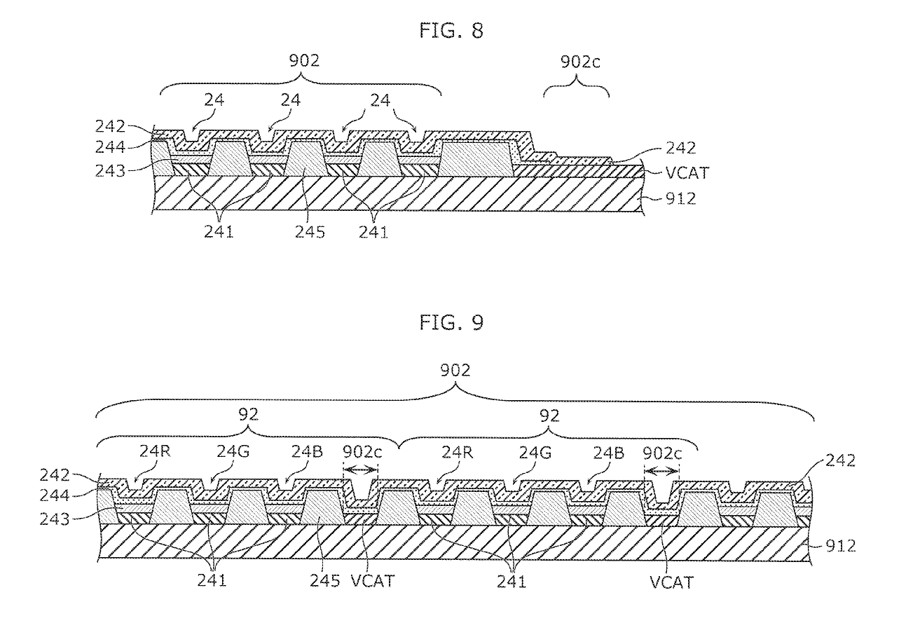

Causes of such non-linearity generated in the resistance value of the contact resistor 25 will be described with reference to the drawings. FIGS. 8 and 9 are schematic sectional views illustrating one example and another example of a contact region in which the contact resistance 25 is generated, respectively. FIG. 8 illustrates a cross-section of a region in which the organic EL element 24 and the contact resistor 25 are disposed. FIG. 9 illustrates a cross-section of a region in which organic EL elements 24R, 24G, and 24B each emitting red light, green light, and blue light and the contact resistor 25 are disposed. The organic EL elements 24R, 24G, and 24B are illustrated in FIG. 9 as one example of the organic EL element 24 illustrated in FIG. 2. In FIGS. 8 and 9, a layer including a thin film transistor and the like in the pixel circuit 90 are omitted.

In the example illustrated in FIG. 8, the organic EL elements 24 corresponding to the pixel circuits 90 are disposed in a display unit 902. The organic EL elements 24 are disposed on a common substrate 912. Each of the organic EL elements 24 includes a first electrode 241, a second electrode 242, a first organic EL layer 243, and a second organic EL layer 244. The organic EL elements 24 are separated from each other by a bank 245. The organic EL elements 24 each may include a layer other than these layers.

The first electrode 241 is the anode of the organic EL element 24, for example, and is separated from first electrodes 241 of its adjacent organic EL elements 24 by the bank 245.

The first organic EL layer 243 is made of an organic material, and is an organic light-emitting layer, for example. The first organic EL layer 243 is separated from the first electrodes 241 of its adjacent organic EL elements 24 by the bank 245. These first organic EL layers 243 may be formed through patterning of the same organic film, or may be formed with different organic films according to the colors of light beams to be emitted, for example.

The second organic EL layer 244 is made of an organic material, and is an electron transport layer, for example. In the example illustrated in FIG. 8, the second organic EL layer 244 is integrally disposed on the first organic EL layer 243 and the bank 245, without patterning on each organic EL element 24. Such a configuration eliminates the patterning step in the formation of the second organic EL layer 244, therefore simplifying the production process of the organic EL element 24. Accompanied by this, mask patterning with high precision is unnecessary, and therefore cost in masking and display panel production can be reduced.

The second electrode 242 is the cathode of the organic EL element 24, for example. In the example illustrated in FIG. 8, the second electrode 242 is integrally disposed on the second organic EL layer 244, without patterning on each organic EL element 24. Such a configuration eliminates the patterning step in the formation of the second electrode 242, therefore simplifying the production process of the organic EL element 24.

In the example illustrated in FIG. 8, the cathode power supply line VCAT is disposed external to the display unit 902. The cathode power supply line VCAT may be formed with the same electroconductive material as that of the first electrode 241, for example. The cathode power supply line VCAT is in contact with the second electrode 242 in the contact region 902c external to the display unit 902. The contact resistance 25 is generated in the contact region 902c.

Unlike the example illustrated in FIG. 8, the cathode power supply line VCAT and the contact region 902c are disposed in the display unit 902 in the example illustrated in FIG. 9. Each of the pixels 92 disposed in the display unit 902 includes organic EL elements 24R, 24G, and 24B which emit red light, green light, and blue light, respectively. The organic EL elements 24R, 24G, and 24B have the same configurations as illustrated in FIG. 8. The first organic EL layers 243 included in the organic EL elements 24R, 24G, and 24B may be formed with different organic materials.

In the examples illustrated in FIGS. 8 and 9, for example, the organic EL layer is disposed between the cathode power supply line VCAT and the second electrode 242 in the contact region 902c. In such a configuration, the contact resistor 25 may have diode properties as in the organic EL element 24. As a result, the resistance value of the contact resistor 25 has non-linearity as illustrated in FIG. 7.

Any other configuration can impart the non-linearity to the resistance value of the contact resistor 25. For example, a thin insulating film may be disposed on the surface of the first electrode 241 to enhance the light emitting efficiency of the organic EL element 24. In this case, for simplification of the production process, the cathode power supply line VCAT is formed with the same material as that of the first electrode 241 in the same step of forming the first electrode. Such a procedure allows an insulating film to be formed on the surface of the cathode power supply line VCAT as well as the surface of the first electrode. In this case, the resistance value of the contact resistor 25 also may have the non-linearity.

Any other configuration of the contact region 902c than those illustrated in FIGS. 8 and 9 can be used. For example, while each organic EL element includes separated layers and non-separated layers in FIGS. 8 and 9, the organic EL element may include one of separated layers and non-separated layers. While FIG. 9 illustrates a configuration in which each pixel 992 includes organic EL elements which emit red light, green light, and blue light, each pixel 92 may further include another organic EL element which emits white light.

Each pixel 92 may include only an organic EL element which emits light of one color. While the cathode power supply line VCAT is disposed in each pixel 92 in the example illustrated in FIG. 9, a single cathode power supply line VCAT may be disposed for a plurality of pixels 92.

While the formation of the cathode power supply line VCAT with the same material in the same step as those of the first electrode 241 has been exemplified, at least part of the cathode power supply line VCAT may be formed with the same material as that of the layer for forming a thin film transistor included in the pixel circuit 90 in the same step of forming the thin film transistor.

The description of the phenomena occurring in the pixel circuit 90 will be resumed. The second electrode of the organic EL element 24 illustrated in FIG. 6 is shared in the pixel circuits 90. For this reason, accompanied by a reduction in potential of the second electrode in one pixel circuit 90, the potential of the second electrode of a different pixel circuit 90 disposed near the pixel circuit also reduces (see the arrow (1) in FIG. 6). Accompanied by the reduction in potential of the second electrode of the different pixel circuit 90, the potential of the first electrode connected through the second electrode and the EL capacitance element 22 also reduces (see the arrow (2) in FIG. 6). At this time, in the case where threshold compensation control is performed in the different pixel circuit 90 (during the period from the point of time T4 to the point of time T5 in FIG. 4), the reduction in potential of the first electrode, i.e., the potential Vs of the source electrode s of the drive transistor TD may obstruct appropriate compensation of the threshold voltage. In other words, the reduction in potential Vs of the source electrode s of the drive transistor TD increases the voltage retained in the capacitance element 20 to exceed the threshold voltage (see the arrow (3) in FIG. 6). When the period of the threshold compensation operation still continues even after the occurrence of such a phenomenon, the voltage retained in the capacitance element 20 is approximated to the threshold voltage of the drive transistor TD by charging and discharging of the capacitance element 20 and the EL capacitance element 22. However, in the case where the phenomenon occurs immediately before the end of the period of the threshold compensation operation (during the period from the point of time T4 to the point of time T5 in FIG. 2), the period of threshold voltage compensation terminates while the voltage retained in the capacitance element 20 remains higher than the threshold voltage. For this reason, in the case where the voltage corresponding to the data signal is applied to the different pixel circuit 90, the voltage retained in the capacitance element 20 is higher than the voltage corresponding to the data signal. Accompanied by this, the luminance of the organic EL element 24 becomes higher than the luminance corresponding to the data signal.

As described above, accompanied by the initialization control in one pixel circuit 90, the luminance of the organic EL element 24 in the different pixel circuit 90 may become higher than the luminance corresponding to the data signal. However, in the pixels near the scan terminal in the vertical scan direction in the display unit 902, the initialization control is not performed in the different pixel circuits 90 during the period of threshold compensation control. For this reason, such a phenomenon of increasing the luminance never occurs. This phenomenon will be described with reference to the drawings.

FIG. 10 is a graph illustrating a potential waveform of the second electrode (or the cathode) of the pixel circuit 90 during one frame period in the display device 900 in the related art. FIG. 10 illustrates the potential of the second electrode of the organic EL element 24 in the display unit 902 in which the pixel circuits 90 are arranged into a matrix. All of the second electrodes of the pixel circuits 90 in the display unit 902 are connected to each other. In other words, all of the second electrodes of the pixel circuits 90 are formed with a single electroconductive film. FIG. 10 illustrates a waveform in the case where the vertical scan in the display unit 902 is performed in the direction from the upper row of the display unit 902 to the lower row thereof.

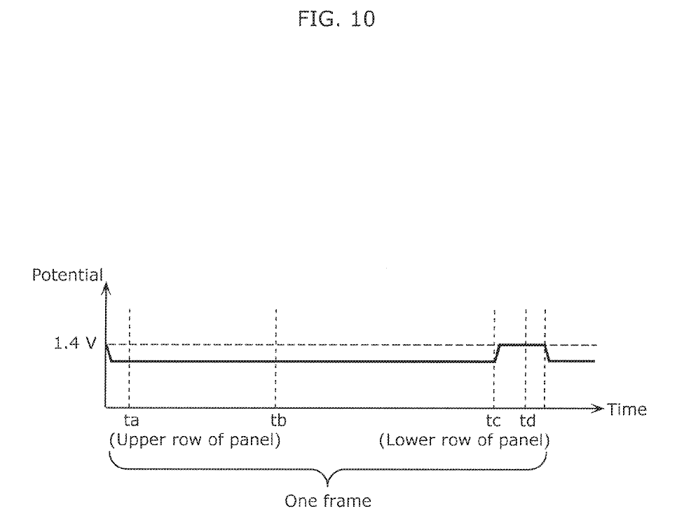

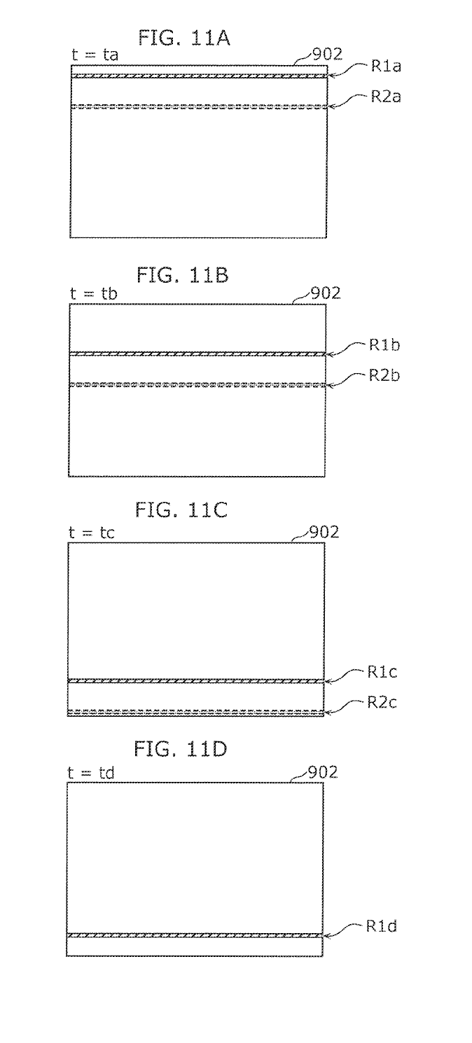

FIGS. 11A to 11D are schematic views illustrating the positions in the display unit 902 at the points of time t=ta to td, respectively, in the display device 900 in the related art, the positions corresponding to the row containing the pixel circuit 90 subjected to the threshold compensation control and the row containing the pixel circuit 90 subjected to the initialization control. FIGS. 11A to 11D illustrate the rows R1a to R1d each containing the pixel circuits 90 subjected to the threshold compensation control and the rows R2a to R2c each containing the pixel circuit 90 subjected to the initialization control, respectively.

As illustrated in FIGS. 11A to 11C, until the point of time t=tc, the different pixel circuit 90 (rows R2a to R2c) is subjected to the initialization control when the pixel circuit 90 is subjected to the threshold compensation control. As described with reference to FIG. 5, thereby, the potential of the second electrode of the different pixel circuit 90 becomes lower than the potential of the cathode power supply line VCAT. Here, all of the second electrodes of the pixel circuits 90 are connected to each other. For this reason, the potential of the second electrode of the organic EL element 24 in the pixel circuit 90 subjected to the threshold compensation control until the point of time t=tc becomes lower than the potential (about 1.4 V) of the cathode power supply line VCAT connected to the second electrode via the contact resistor 25 (see FIG. 10). For this reason, until the point of time t=tc, the luminance of the organic EL element 24 is higher than the luminance corresponding to the data signal.

In contrast, at the point of time after the point of time t=tc, the different pixel circuit 90 is not subjected to the initialization control when the pixel circuit 90 is subjected to the threshold compensation control. In other words, the initialization control is not performed on all of the pixel circuits 90. Accordingly, there is no cause to reduce the potential of the second electrode at the point of time after the point of time t=tc, and therefore the potential of the second electrode is substantially equal to the potential of the cathode power supply line VCAT (about 1.4 V) as illustrated in FIG. 10. Accordingly, the potential of the second electrode of the organic EL element 24 in the pixel circuit 90 subjected to the threshold compensation control at a point of time after the point of time t=tc is substantially equal to the potential of the cathode power supply line VCAT. For this reason, the luminance of the organic EL element 24 amounts to the luminance corresponding to the data signal.

When such a phenomenon occurs, the region 902a having a luminance lower than that of another region is generated in the lower portion of the display unit 902 in FIG. 3.

Accordingly, an object of the present disclosure is to provide a display device including an organic EL element while the uneven luminance described above is reduced.

To achieve the object above, the display device according to one aspect of the present disclosure includes a display panel, and a control circuit which controls the display panel. The display panel includes pixel circuits arranged into a matrix in a display region of the display panel, and one or more dummy pixel circuits disposed external to the display region. Each of the pixel circuits includes an organic EL element having a first electrode and a second electrode, a capacitance element which retains voltage, and a drive transistor which is connected to the first electrode of the organic EL element and feeds a current corresponding to the voltage retained in the capacitance element to the organic EL element. Each of the one or more dummy pixel circuits includes a dummy capacitance element having a first dummy electrode, and a second dummy electrode shared with the second electrode of the organic EL element. The control circuit performs at least one of initialization controls within a period for which threshold compensation control to compensate for a threshold voltage of the drive transistor is performed on each of the pixel circuits, the initialization controls being initialization control to initialize the potential of the first electrode of the organic EL element in at least one different pixel circuit among the pixel circuits and dummy initialization control to initialize the potential of the first dummy electrode of the dummy capacitance element.

In such a configuration, the potential of the second electrode of the organic EL element can be reduced in all the pixel circuits during the period of threshold compensation operation. Thereby, the difference in operational conditions between the pixel circuits can be reduced. For this reason, the display device according to the present disclosure can reduce the uneven luminance of the display panel.

In the display device according to one aspect of the present disclosure, the control circuit may scan the target pixel circuits for light emission in a vertical scan direction among the pixel circuits arranged into the matrix, and the one or more dummy pixel circuits may be disposed in the vertical scan direction with respect to the display region.

In such a configuration, by scanning the target pixel circuits for light emission toward the region in which the dummy pixel circuit(s) is disposed, the distance between the pixel circuit subjected to the threshold compensation control and the dummy pixel circuit during the initialization control of the dummy pixel circuit can be reduced. Thereby, influences of a reduced potential of the second electrode of the organic EL element caused by the initialization control of the dummy pixel circuit can be more surely imparted to the pixel circuit subjected to the threshold compensation control.

In the display device according to one aspect of the present disclosure, the one or more dummy pixel circuits may be disposed in a region adjacent to the pixel circuits in a last scanned row among the pixel circuits arranged into the matrix.

Such a configuration can reduce the distance between the pixel circuit subjected to the threshold compensation control and the dummy pixel circuit during the initialization control of the dummy pixel circuit.

In the display device according to one aspect of the present disclosure, the one or more dummy pixel circuits may be disposed on both sides of the display region in the vertical scan direction.

Such a configuration can reduce the distance between the pixel circuit subjected to the threshold compensation control and the dummy pixel circuit during the initialization control of the dummy pixel circuit, irrespective of whether the vertical scan of the pixel circuits is performed in either vertical direction.

In the display device according to one aspect of the present disclosure, among the pixel circuits arranged into the matrix, the one or more dummy pixel circuits do not need to be disposed in the vertical scan direction of the pixel circuit located at at least one of ends of the last scanned row.

In such a configuration, a vacant space can be disposed at a corner of the display panel in which the dummy pixel circuit is not disposed.

In the display device according to one aspect of the present disclosure, the one or more dummy pixel circuits may be disposed in multiple regions aligned in a horizontal scan direction of the pixel circuits.

In the display device according to one aspect of the present disclosure, the one or more dummy pixel circuits may be arranged into a matrix, and the number of rows of the one or more dummy pixel circuits disposed may be equal to the number of horizontal scan periods contained in a vertical blanking interval in one frame period of the display panel.

Such a configuration can reduce the uneven luminance of the display device by scanning the dummy pixel circuits through the vertical blanking interval as in the pixel circuits.

In the display device according to one aspect of the present disclosure, the one or more dummy pixel circuits may be arranged into a matrix, and the number of dummy pixel circuits in each row of the one or more dummy pixel circuits arranged into the matrix may decrease with distance from the display region.

Such a configuration gradually reduces the luminance of the organic EL element in the vertical direction, and the uneven luminance of the display device becomes unremarkable. Moreover, a vacant space can be disposed at a corner of the display panel in which the dummy pixel circuit is not disposed.

In the display device according to one aspect of the present disclosure, the one or more dummy pixel circuits may be arranged into a matrix, and the number of rows of the one or more dummy pixel circuits disposed may be smaller than the number of horizontal scan periods contained in a blanking interval in one frame period of the display panel.

In such a configuration, the dummy pixel circuit contained in a specific row is subjected to the initialization control several times in the one frame period. Thereby, the initialization control of the dummy pixel circuit can be performed during the period for which the threshold compensation control is performed, in all of the pixel circuits where the different pixel circuit 90 is not subjected to the initialization control within the period for which the threshold compensation control is performed.

In the display device according to one aspect of the present disclosure, the display panel may include an initialization power supply line which feeds an initialization voltage to the pixel circuits. The initialization power supply line may include a horizontal scan direction wiring extending in a horizontal scan direction of the pixel circuits and a vertical scan direction wiring extending in a vertical scan direction of the pixel circuits. The vertical scan direction wiring may have a larger resistance per unit length than a resistance of the horizontal scan direction wiring.

Such a configuration can reduce influences of the increased number of variations in potential while reducing the amount of variation in potential of the initialization power supply line.

In the display device according to one aspect of the present disclosure, the pixel circuit may further include a reference power supply line to which a reference voltage is applied, a reference transistor connected between the reference power supply line and a gate electrode of the drive transistor, a data signal line to which a voltage corresponding to a current fed to the organic EL element is applied, and a writing transistor connected between the data signal line and the gate electrode of the drive transistor.

In the display device according to one aspect of the present disclosure, the reference transistor may have a lightly doped drain (LDD) having a larger length than a length of the writing transistor.

Such a configuration can reduce the leakage current in the reference transistor of the pixel circuit.

In the display device according to one aspect of the present disclosure, a ratio of a channel width to a channel length in the reference transistor may be smaller than a ratio of a channel width to a channel length in the writing transistor.

Such a configuration can reduce the leakage current in the reference transistor of the pixel circuit.

In the display device according to one aspect of the present disclosure, the reference transistor may have a larger number of gates than the number of gates in the writing transistor.

Such a configuration can reduce the leakage current in the reference transistor of the pixel circuit.

In the display device according to one aspect of the present disclosure, the reference transistor may include two gates and a semiconductor layer which forms a channel layer, and in a plan view of the semiconductor layer, the semiconductor layer disposed between the two gates may have an L shape.

Such a configuration can reduce the leakage current in the reference transistor of the pixel circuit.

Embodiments according to the present disclosure will now be described with reference to the drawings. The embodiments described below illustrate specific examples of the present disclosure.

Accordingly, numeric values, shapes, materials, components, arrangement positions and connection forms of the components, steps, and orders of the steps illustrated in the following embodiments are only exemplary, and are not intended to be limitative to the present disclosure. Accordingly, among the components of the following embodiments, the components not described in an independent claim representing the most superordinate concept of the present disclosure are described as arbitrary components.

The drawings are schematic views, and are not always strict illustrations. Accordingly, the drawings are not always drawn to scale. In the drawings, identical reference numerals are given to substantially identical configurations, and the duplication of description will be omitted or the description will be simplified.

### Embodiment 1

A display device according to Embodiment 1 will be described.

### [1-1. The Entire Configuration]

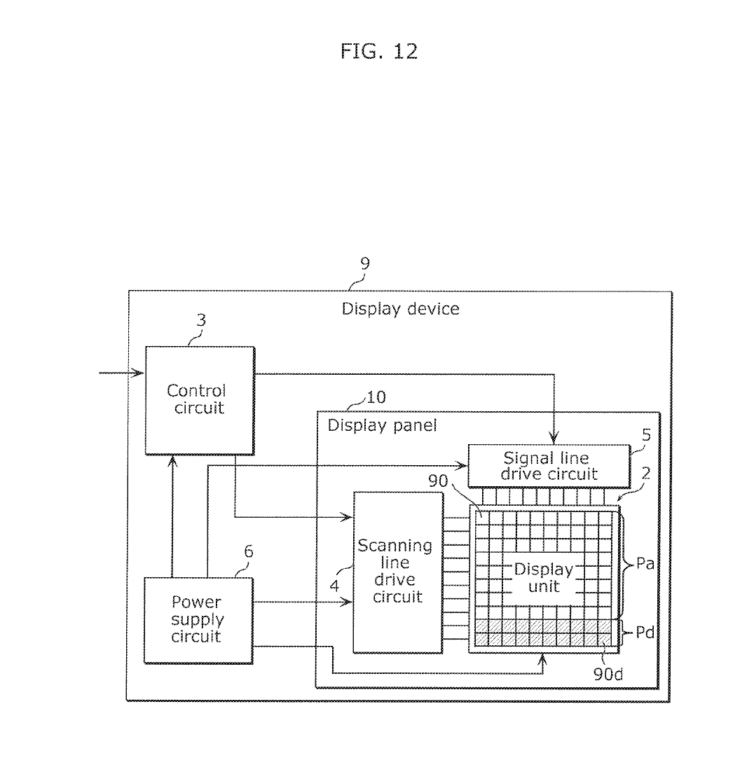

First, the entire configuration of a display device 9 according to the present embodiment will be described with reference to the drawings. FIG. 12 is a block diagram illustrating a functional configuration of the display device 9 according to the present embodiment. The display device 9 is an image display device such as an organic EL display. As illustrated in FIG. 12, the display device 9 includes a display panel 10 and a control circuit 3. The display device 9 further includes a power supply circuit 6. The display panel 10 includes a display unit 2, a scanning line drive circuit 4, and a signal line drive circuit 5.

The control circuit 3 controls the display panel 10. The control circuit 3 receives an external video signal, and controls the scanning line drive circuit 4 and the signal line drive circuit 5 such that an image represented by the video signal is displayed in the display unit 2.

The power supply circuit 6 feeds the voltage for operating the display device 9 to the components of the display device 9.

The display unit 2 includes pixel circuits 90 arranged into a matrix in a display region Pa of the display panel 10, and one or more dummy pixel circuits 90d disposed in an external region (dummy region Pd) of the display region. The rows of the pixel circuits 90 arranged into the matrix include control signal lines, and the control signal lines in each row are disposed to be commonly connected to the pixel circuits 90 in the row. The columns of the matrix include data signal lines SIG, and the data signal line SIG in each column is disposed to be commonly connected to the pixel circuits 90 in the column.

Each of the pixel circuits 90 has the same configuration as that of the pixel circuit 90 described in the related art. As illustrated in FIG. 2, the pixel circuit 90 includes an organic EL element 24 having a first electrode and a second electrode, and a capacitance element 20 for retaining voltage. The pixel circuit 90 further includes a drive transistor TD which is connected to the first electrode of the organic EL element 24 and feeds a current corresponding to the voltage retained in the capacitance element 20 to the organic EL element. The pixel circuit 90 further includes a reference transistor TREF, a writing transistor TWS, and an initialization transistor TINI. Each of the pixel circuits 90 is connected to a reference signal line REF, a writing signal line WS, and an initialization signal line INI which feed control signals output from the scanning line drive circuit 4. Each of the pixel circuits 90 is connected to a data signal line SIG which feeds a data signal output from the signal line drive circuit 5.

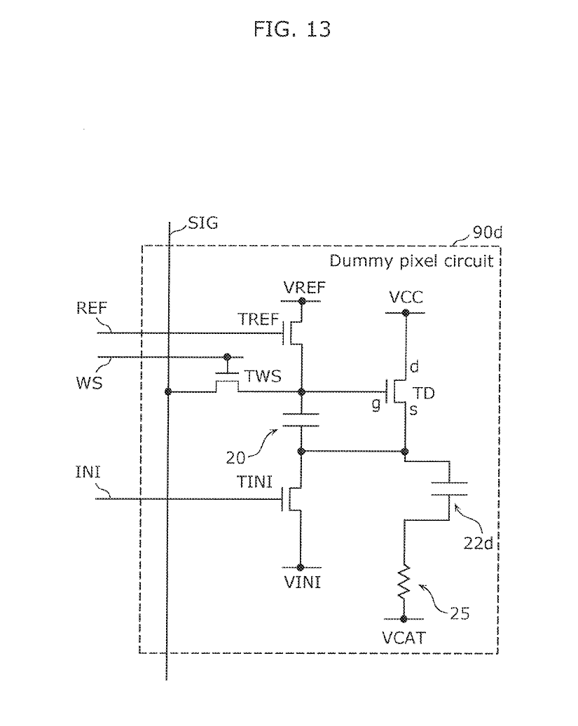

The one or more dummy pixel circuits 90d will be described with reference to the drawing. FIG. 13 is a circuit diagram illustrating one example of a dummy pixel circuit 90d included in the display device 9 according to the present embodiment. As illustrated in FIG. 13, each of the one or more dummy pixel circuits 90d includes a dummy capacitance element 22d having a first dummy electrode and a second dummy electrode. The second dummy electrode of the dummy pixel circuit 90d is shared with the second electrode of the organic EL element 24 in the pixel circuit 90.

In the example illustrated in FIG. 13, the dummy pixel circuit 90d is the same as the pixel circuit 90 except that the dummy pixel circuit 90d includes the dummy capacitance element 22d rather than the organic EL element 24. In other words, the dummy pixel circuit 90d includes the dummy capacitance element 22d, the capacitance element 20, the drive transistor TD, the reference transistor TREF, the writing transistor TWS, and the initialization transistor TINI.

Among the two electrodes of the dummy capacitance element 22d, the first dummy electrode of the dummy capacitance element 22d is connected to the source electrode s of the drive transistor TD. Among the two electrodes of the dummy capacitance element 22d, the second dummy electrode of the dummy capacitance element 22d is connected to the cathode power supply line VCAT. The second dummy electrode may be formed with the same electroconductive film as that of the second electrode of the organic EL element 24 in the pixel circuits 90.

The dummy pixel circuit 90d is connected to a reference signal line REF, a writing signal line WS, and an initialization signal line INI which feed control signals output from the scanning line drive circuit 4. The dummy pixel circuit 90d is connected to a data signal line SIG which feeds a data signal output from the signal line drive circuit 5.

The organic EL element 24 can be used as the dummy capacitance element 22d, for example. Such a configuration enables the dummy pixel circuit 90d to have a configuration common to that of the pixel circuit 90, simplifying the production process of the display panel 10. In the inspection process, this configuration can facilitate the inspection of the operation of the dummy pixel circuit 90d by performing light emission of the organic EL element 24 as the dummy capacitance element 22d. In the inspection process, the light emitting efficiency, the current-voltage properties, and the chromaticity of the organic EL element 24 can be also inspected by operating the dummy pixel circuit 90d to perform light emission of the organic EL element 24. The organic EL elements 24 can be evaluated through such an inspection of the organic EL element 24 using the dummy pixel circuit 90d without using the pixel circuits 90. For this reason, the organic EL elements 24 can be inspected without degrading the organic EL elements 24 of the pixel circuits 90.

In addition, in a configuration in which the signal lines connected to the dummy pixel circuits 90d are drawn separately from the signal lines connected to the pixel circuits 90, these signal lines can be used to feed signals only to the dummy pixel circuits 90d. Such a configuration can further simplify the inspection device.

In the case where the organic EL element 24 is used as the dummy capacitance element 22d of the dummy pixel circuit 90d, a black matrix may be disposed on the light-emitting face of the organic EL element 24 to prevent leakage of the light emitted from the organic EL element 24, i.e., the dummy capacitance element 22d to the outside of the dummy pixel circuit 90d. The black matrix may be disposed after the inspection of the dummy pixel circuits 90d.

The step of forming such a black matrix may be achieved, for example, by bonding a color filter having a black matrix to the display panel after the inspection of the dummy pixel circuit 90d. A data signal corresponding to the color of black (black data) may be applied to the dummy pixel circuit 90d. Such an operation can reduce the power consumption in the dummy pixel circuit 90d.

The dummy capacitance element 22d may be a capacitance element having a capacitance equal to that of the EL capacitance element 22 in the organic EL element 24. Such a dummy capacitance element 22d may be an organic EL element 24 without the light emission layer, for example. In such a configuration, it is unnecessary to dispose the black matrix on the light-emitting face or applying black data to the dummy pixel circuit 90d because a non-light-emitting element can be used as the dummy capacitance element 22d.

Alternatively, the dummy capacitance element 22d may be an element including at least one layer disposed between the first dummy electrode and the second dummy electrode, the at least one layer being selected from the layers disposed between the two electrodes of the organic EL element 24. In such a configuration, by appropriately selecting the layers disposed between the first dummy electrode and the second dummy electrode, a dummy capacitance element 22d having a smaller film thickness between the first dummy electrode and the second dummy electrode than that of the organic EL element 24 can be achieved. In other words, a dummy capacitance element 22d having a larger capacitance than that of the organic EL element 24 can be achieved. Use of such a dummy capacitance element 22d can further increase the coupling between the first dummy electrode and the second dummy electrode.

Accordingly, a reduction in potential of the second dummy electrode accompanied by a reduction in potential of the first dummy electrode can be further ensured in the initialization control.

Alternatively, only an organic EL element 24 of a light-emitting color having the largest capacitance may be used as the dummy capacitance element 22d. In other words, organic EL elements 24 of three to four light-emitting colors such as RGB or RGBW are included in the pixel circuits 90 of the display device 9. Among these organic EL elements 24, only the organic EL element having the largest capacitance may form the dummy capacitance element 22d. For example, the dummy capacitance element 22d may be formed of only an organic EL element 24 having a light-emitting color of blue. Such a configuration can further increase the coupling between the first dummy electrode and the second dummy electrode, and simplify the production process of the dummy capacitance element 22d.

In addition, a bank or rib for partitioning the organic EL elements 24 between the dummy pixel circuits may be eliminated in the case where the organic EL element 24 is used as the dummy capacitance element 22d. Such a configuration can increase the opening for the organic EL element 24 as the dummy capacitance element 22d, increasing the capacitance of the dummy capacitance element 22d.

Alternatively, the dummy capacitance element 22d may be an element including a bank or rib which embeds the space between the first dummy electrode and the second dummy electrode. In such a configuration, the film thickness of the bank or rib may be reduced in the case where the film thickness can be varied. Such a reduced film thickness can increase the capacitance of the dummy capacitance element 22d.

Alternatively, the dummy capacitance element 22d may be an element including any insulating film which embeds the space between the first dummy electrode and the second dummy electrode. In such a configuration, the film thickness of the insulating film may be adjusted in the case where the film thickness can be varied, controlling the capacitance of the dummy capacitance element 22d.

The scanning line drive circuit 4 feeds control signals for controlling the operation of the pixel circuit 90 through the control signal line to the pixel circuit 90. In the present embodiment, the scanning line drive circuit 4 outputs the control signals, i.e., a reference signal, an initialization signal, and a writing signal. The reference signal, the initialization signal, and the writing signal are fed through the reference signal line REF, the initialization signal line INI, and the writing signal line WS to the reference transistor TREF, the initialization transistor TINI, and the writing transistor TWS, respectively. The scanning line drive circuit 4 may feed the control signals to the dummy pixel circuit 90d.

The signal line drive circuit 5 feeds a data signal through the data signal line SIG to the pixel circuit 90 according to the luminance of emitted light. The signal line drive circuit 5 may also feed a data signal to the dummy pixel circuit 90d.

The control circuit 3 controls the operation of the display device 9. The control circuit 3 receives an external video signal, and controls the scanning line drive circuit 4 and the signal line drive circuit 5 such that an image represented by the video signal is displayed in the display region Pa of the display unit 2.

The power supply circuit 6 feeds a voltage for operating the display device 9 to the components of the display device 9.

### [1-2. Operation]

The operation of the display device 9 according to the present embodiment will be described. In the display device 9 according to the present embodiment, the control circuit 3 performs the operation on the pixel circuits 90 as described in the operation of the control circuit 903 of the display device 900 in the related art with reference to the timing chart in FIG. 4. Furthermore, in the display device 9 according to the present embodiment, the control circuit 3 performs at least one of initialization controls within a period for which threshold compensation control to compensate for the threshold voltage of the drive transistor TD is performed on each of the pixel circuits 90, the initialization controls being initialization control to initialize the potential of the first electrode of the organic EL element 24 in at least one different pixel circuit 90 of the pixel circuits 90 and dummy initialization control to initialize the potential of the first dummy electrode of the dummy capacitance element 22d in the dummy pixel circuit 90d. The operation of the display device 9 according to the present embodiment will now be described in comparison with that of the display device 900 in the related art.

Similarly to the display device 900 in the related art, there is a case where the display device 9 according to the present embodiment does not perform the initialization control on the different pixel circuit 90 within the period for which the threshold compensation control is performed on the pixel circuit 90 (see FIG. 11D). In such a case, in the display device 9 according to the present embodiment, the control circuit 3 performs the dummy initialization control to initialize the potential of the first dummy electrode of the dummy capacitance element 22d in the dummy pixel circuit 90d. Thereby, the potential of the first dummy electrode of the dummy capacitance element 22d reduces as in the case where the initialization control is performed on the pixel circuit 90. Here, the second dummy electrode of the dummy capacitance element 22d is shared with the second electrode of the organic EL element 24.

For this reason, the reduction in potential of the first dummy electrode reduces the potential of the second electrode of the organic EL element 24. Thereby, the potential of the second electrode of the organic EL element 24 can be reduced in all of the pixel circuits 90 during the period of performing the threshold compensation operation. Accompanied by this, as described in the display device 900 in the related art, the organic EL element 24 can emit light having a luminance higher than the luminance according to the data signal. For this reason, the display device 9 according to the present embodiment can reduce the uneven luminance generated in the display device 900 in the related art, which is described with reference to FIG. 3.

As in the display device 900 in the related art, in the display device 9 according to the present embodiment, the control circuit 3 scans the target pixel circuits 90 for light emission in the vertical direction (in other words, the direction from top to bottom in FIG. 12) among the pixel circuits 90 arranged into the matrix. As illustrated in FIG. 12, the one or more dummy pixel circuits 90d are disposed in the vertical scan direction with respect to the display region Pa.

In this case, by scanning the target pixel circuits 90 for light emission toward the region in which the dummy pixel circuits 90d are disposed, the distance between the pixel circuit 90 subjected to the threshold compensation control and the dummy pixel circuit 90d during the initialization control of the dummy pixel circuit 90d can be reduced. In other words, in the example illustrated in FIG. 12, by scanning the target pixel circuits 90 for light emission from top to bottom in FIG. 12, the distance between the pixel circuit 90 subjected to the threshold compensation control and the dummy pixel circuit 90d during the initialization control of the dummy pixel circuit 90d can be reduced. Thereby, influences of a reduced potential of the second electrode of the organic EL element 24 caused by the initialization control on the dummy pixel circuit 90d can be more surely imparted to the pixel circuit 90 subjected to the threshold compensation control.

The number of rows of dummy pixel circuits 90d may be smaller than that of rows containing the pixel circuit 90 where the different pixel circuit 90 is not subjected to the initialization control within the period for which the threshold compensation control is performed on the pixel circuit 90.

For example, only one row of dummy pixel circuits 90d may be disposed. Because unlike in the display region Pa, the dummy pixel circuit 90d does not need to emit light during one frame period, only one row of dummy pixel circuits 90d may be disposed as long as these dummy pixel circuits 90d in the row can be initialized for each period of one horizontal scan. In the case where only one row of dummy pixel circuit 90d is disposed, a voltage different from the initialization voltage is input to the first dummy electrode such that the potential varies within the period of one horizontal scan between the initialization control and the next initialization control. Thereby, a reduction in potential of the second electrode can be achieved. During the input of the voltage different from the initialization voltage, a potential changed in the opposite direction to the initialization voltage may be conducted to the second dummy electrode due to capacitive coupling. For this reason, the voltage different from the initialization voltage may be slowly charged into the first dummy electrode of the dummy pixel circuit 90d so as to avoid the generation of capacitive coupling.

To perform a simple dummy initialization control without performing the control described above, at least two rows of dummy pixel circuits 90d are disposed. In this case, among the at least two rows of dummy pixel circuits 90d, the initialization control is performed in one row, and the voltage different from the initialization voltage is applied to the other row. As described above, the initialization control and the application of the voltage different from the initialization voltage are repeatedly performed.

The cycle of the initialization control and the application of the voltage different from the initialization voltage is different according to the number of rows of dummy pixel circuits 90d. At two rows, the initialization control and the application of the voltage different from the initialization voltage are repeated alternately for each period of one horizontal scan. At three or more rows, the row subjected to the initialization control is sequentially changed for each period of one horizontal scan while the voltage different from the initialization voltage is applied to the row not subjected to the initialization control.

In the case where the time from the end point of time of the initialization control to the start point of time of the next initialization control is longer than the time needed to apply the voltage different from the initialization voltage, a period in which the state is retained without applying the voltage may be disposed.

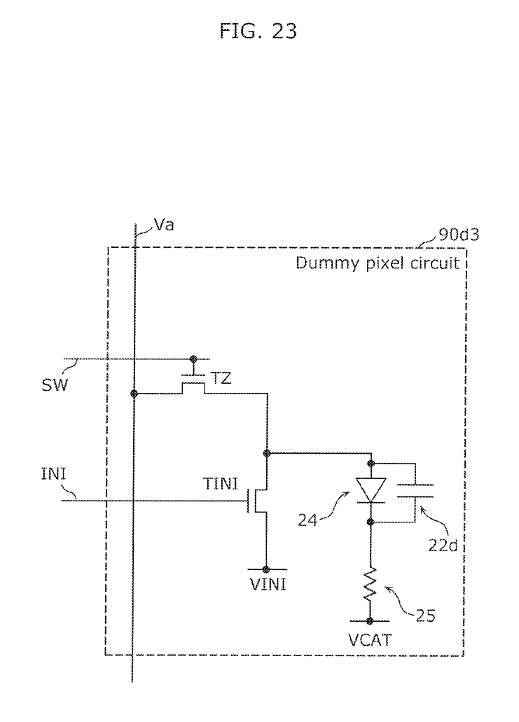

The voltage different from the initialization voltage may be, for example, a reference voltage or a voltage of a data signal, or a voltage other than the voltage used in the pixel circuit 90 (the voltage applied to a dummy signal line Va described later with reference to FIG. 23).

In the display device 9 according to the present embodiment, the one or more dummy pixel circuits 90d are disposed in a region adjacent to the pixel circuits 90 of the last scanned row among the pixel circuits 90 arranged into the matrix.

Thereby, the distance between the pixel circuit 90 subjected to the threshold compensation control and the dummy pixel circuit 90d during the initialization control of the dummy pixel circuit 90d can be reduced. The region adjacent to the pixel circuits 90 of the last scanned row refers to the region which is disposed external to the display region Pa and spans between the pixel circuits 90 of the last scanned row and the edge of the display panel 10 opposite to the pixel circuits 90 of the last scanned row. For example, the region can include a region or component other than the region adjacent to the pixel circuits 90 of the last scanned row. Another circuit may be interposed between the pixel circuits 90 and the dummy pixel circuits 90d.

Although one of the initialization control and the dummy initialization control is performed during the threshold compensation control in the above description, both thereof may be performed at the same time. For example, the luminance may be slightly adjusted by performing the dummy initialization control while the initialization control is being performed.

### [1-3. Modifications of Dummy Region]

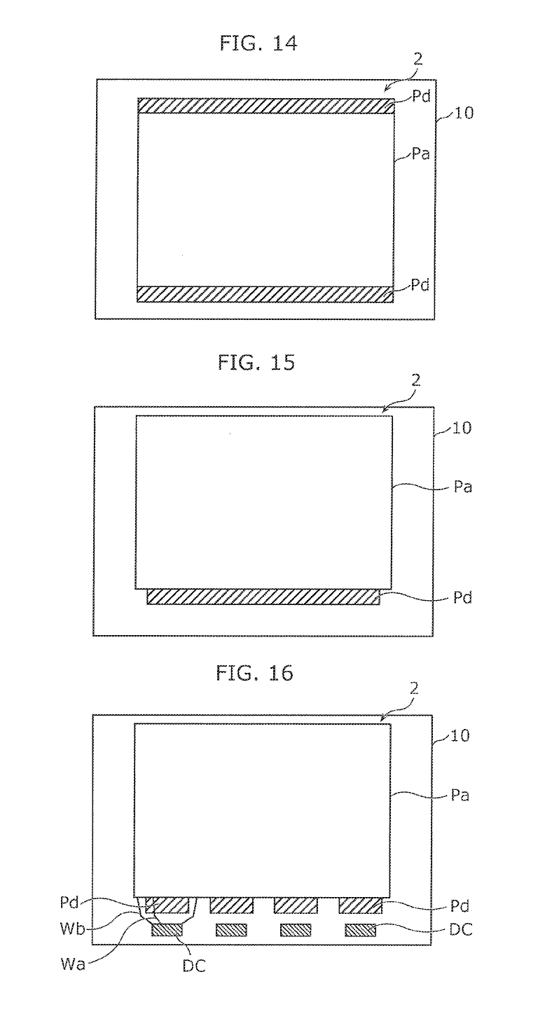

Modifications of the dummy region Pd in which the dummy pixel circuit 90d according to the present embodiment is disposed will be described with reference to the drawings. FIGS. 14 to 20 are schematic plan views of display panels 10 illustrating the arrangement of the dummy region Pd according to Modifications 1 to 7 of the present embodiment, respectively.

As illustrated in FIG. 14, the dummy region Pd may be disposed on both of the upper and lower sides of the display region Pa. In other words, the one or more dummy pixel circuits 90d may be disposed on both sides of the display region Pa in the vertical scan direction. Such a configuration can reduce the distance between the pixel circuit 90 subjected to the threshold compensation control and the dummy pixel circuit 90d during the initialization control of the dummy pixel circuit 90d, irrespective of whether the vertical scan of the pixel circuits 90 is performed in either vertical direction. In other words, for example, in the case where the pixel circuits 90 are scanned upwardly, the uneven luminance of the display device can be reduced using the dummy pixel circuits 90d disposed on the upper side.

As illustrated in FIG. 15, the length of the dummy region Pd in the horizontal scan direction (horizontal direction in FIG. 15) may be shorter than that of the display region Pa in the horizontal scan direction. In other words, among the pixel circuits 90 arranged into the matrix, the dummy pixel circuit 90d does not need to be disposed in the vertical scan direction of the pixel circuit 90 located at at least one of the ends of the last scanned row. Such a configuration can provide a vacant space at a corner of the display panel 10 in which the dummy pixel circuit 90d is not disposed. Such a vacant space may have information, such as the ID of the display panel 10, or the trade mark of the manufacturer. Thereby, an ID and other information can be written in the display panel 10 without enlarging the size of the display panel 10. The number of dummy pixel circuits 90d in the horizontal scan direction does not always need to be the same as that of the pixel circuits 90 in the horizontal scan direction. Even in this case, the uneven luminance in the display device 9 can also be reduced.

Alternatively, as illustrated in FIG. 16, the dummy region Pd may be separated into portions in the horizontal scan direction of the pixel circuit 90. In other words, the one or more dummy pixel circuits 90d may be disposed in multiple regions aligned in the horizontal scan direction of the pixel circuit 90. Such an arrangement can also reduce the uneven luminance in the display device 9.

In addition, as illustrated in FIG. 16, in the case where several signal line drive circuits DC are disposed at positions adjacent to the dummy regions Pd in the vertical scan direction, the dummy pixel circuit 90d can be used to adjust the time constant of the wiring which connects the signal line drive circuit DC to the display unit 2. As in the wiring Wa and the wiring Wb illustrated in FIG. 16, the wirings which connect the signal line drive circuit DC to the display unit 2 may have different lengths. In the example illustrated in FIG. 16, the wiring Wa has a length smaller than that of the wiring Wb. In this case, generally, the wiring Wa has a time constant smaller than that of the wiring Wb. For this reason, the dummy pixel circuit 90d is disposed in the column connected to the wiring Wa while the dummy pixel circuit 90d is not disposed in the column connected to the wiring Wb. In such a configuration, because the time constant of the dummy pixel circuit 90d is added to the time constant of wiring Wa in the passage of the wiring Wa, the time constant of the entire passage of the wiring Wa can be approximated to the time constant of the entire passage of the wiring Wb. As described above, the difference in time constant between the entire passages of the wirings can be reduced.

As described above, by this layout method, the dummy pixel circuit 90d can reduce not only the uneven luminance of the display device, but also the difference in the time constant between the wirings. Thereby, the uneven luminance caused by the difference in the charge rate of the signal line voltage in a predetermined gradation due to the difference in the time constant between the wirings can be reduced. In other words, this layout method can advantageously reduce two types of uneven luminance at the same time.

When the number of rows of dummy pixel circuits 90d is equal to or more than the number of the horizontal scan periods contained in the vertical blanking interval, the initialization control is constantly performed by sequentially scanning the dummy pixel circuits 90d in the vertical scan direction subsequent to the scan of the pixel circuits 90. For this reason, the potential of the second electrode can be kept substantially constant. In contrast, in an alternative method of determining the number of rows of dummy pixel circuits 90d, control is performed such that the row (R2a to R2c in FIGS. 11A to 11C) containing the pixel circuit 90 subjected to the initialization control or the row containing the dummy pixel circuit 90d subjected of the dummy initialization control should be present during a period for which the row (R1a to R1d in FIGS. 11A to 11D) subjected to the threshold compensation control illustrated in FIGS. 11A to 11D is present.

In the example illustrated in FIG. 11A, by adding the dummy pixel circuit 90d on the lower side of the display unit 902 by the number corresponding to the difference between the number of rows from the upper end row of the display region Pa to the row R2a and the number of rows to the row R1a, the initialization control can be performed on the dummy pixel circuit 90d even in the case illustrated in FIG. 11D (the case after the point of time t=tc).

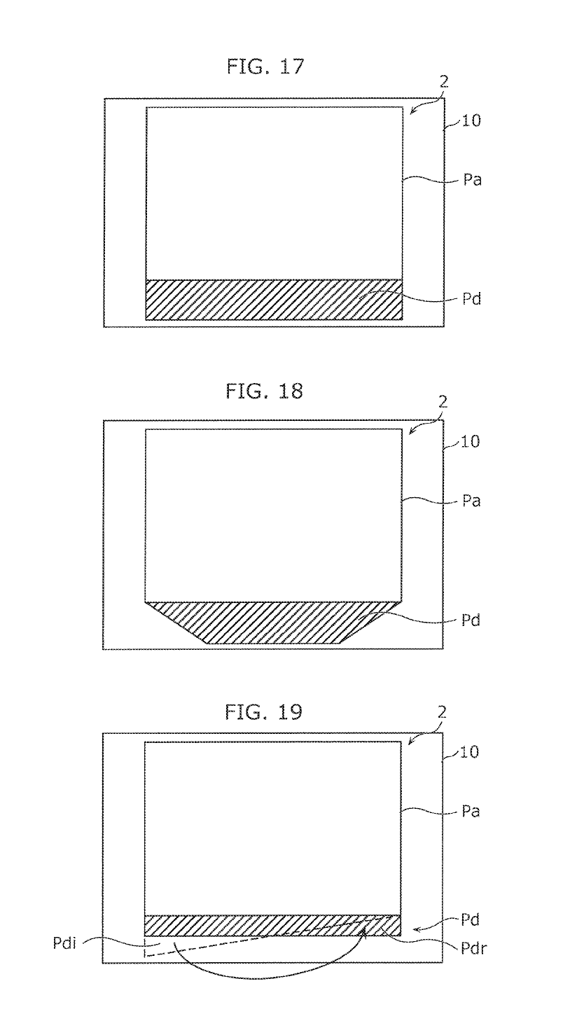

Alternatively, as illustrated in FIG. 17, the one or more dummy pixel circuits 90d may be arranged into a matrix in the dummy region Pd. At this time, the number of rows of the one or more dummy pixel circuits 90d disposed may be equal to the number of horizontal scan periods contained in the vertical blanking interval of one frame period of the display panel 10. Such a configuration can reduce the uneven luminance of the display device 9 by scanning the dummy pixel circuits 90d through the vertical blanking interval as in the pixel circuits 90.

Alternatively, as illustrated in FIG. 18, the one or more dummy pixel circuits 90d may be arranged into a matrix in the dummy region Pd, and the number of dummy pixel circuits 90d in each row of the one or more dummy pixel circuits 90d arranged into a matrix may decrease with distance from the display region Pa. In the case where the dummy pixel circuits 90d are initialized for each row, the effect of reducing the potential of the second electrode of the organic EL element 24 in the pixel circuit 90 is reduced as the number of dummy pixel circuits 90d in each row decreases. In other words, the luminance of the organic EL element 24 is reduced. However, in the example illustrated in FIG. 18, the luminance of the organic EL element 24 is gradually reduced in the vertical scan direction, and the uneven luminance of the display device is barely remarkable. In addition, as in the example illustrated in FIG. 15, a vacant space can be disposed at a corner of the display panel 10 in which the dummy pixel circuit 90d is not disposed.

Here, the configuration of one or more dummy pixel circuits 90d “arranged into a matrix” includes not only configurations in which the rows have the same number of dummy pixel circuits 90d but also configurations in which the number of dummy pixel circuits 90d is varied among the rows.

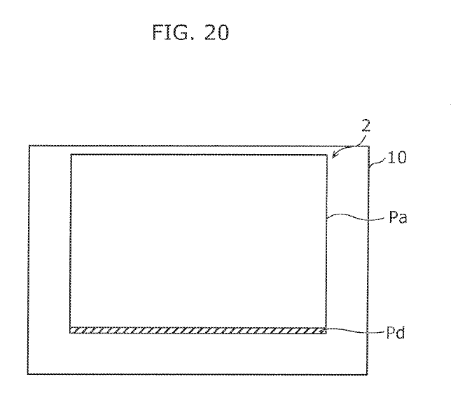

Alternatively, as illustrated in FIG. 19, the one or more dummy pixel circuits 90d may be arranged into a matrix in the dummy region Pd, and the number of rows of the one or more dummy pixel circuits 90d disposed may be smaller than the number of horizontal scan periods contained in the blanking interval in one frame period of the display panel 10. Also in such a configuration, for example, the dummy pixel circuit 90d contained in a specific row may be subjected to the initialization control several times in the one frame period. Thereby, the initialization control of the dummy pixel circuit 90d can be performed during the period for which the threshold compensation control is performed, in all of the pixel circuits 90 where the different pixel circuit 90 is not subjected to the initialization control within the period for which the threshold compensation control is performed.

As represented by the virtual dummy region Pdi in FIG. 19, the dummy region may have a triangular shape. In this case, the number of rows of one or more dummy pixel circuits 90d disposed may also be equal to the number of horizontal scan periods contained in the vertical blanking interval in one frame period of the display panel 10. Furthermore, the arrangement position of the dummy pixel circuit 90d contained in the virtual dummy region Pdi in FIG. 19 may be moved to an alternative dummy region Pdr without changing the timing of the operation of the dummy pixel circuit 90d. Such a configuration can reduce the width of the frame of the display panel 10.

As illustrated in FIG. 20, only one row of one or more dummy pixel circuits 90d may be disposed. Such a configuration can also reduce the uneven luminance of the display device 9 by repeatedly performing the initialization control on the one row of dummy pixel circuits 90d for each period of one horizontal scan.

### [1-4. Modifications of Dummy Pixel Circuit]

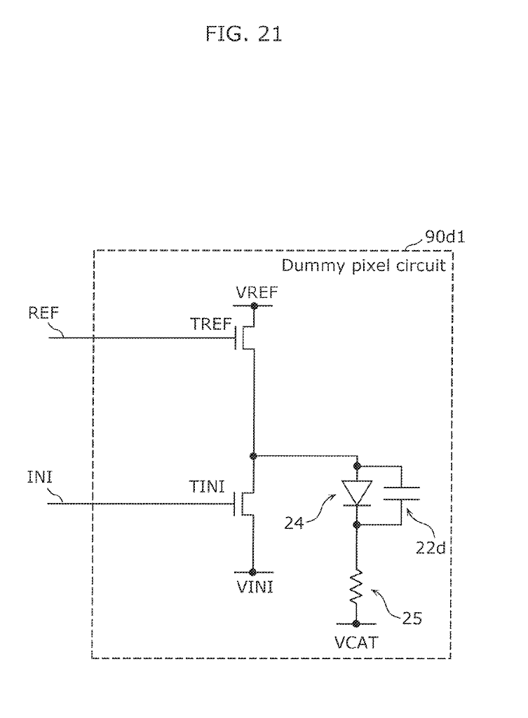

Modifications of the circuit configuration of the dummy pixel circuit 90d according to the present embodiment will be described with reference to the drawings. FIGS. 21 to 23 are circuit diagrams illustrating the circuit configurations of the dummy pixel circuits according to Modifications 8 to 10 of the present embodiment, respectively.

The dummy pixel circuit 90d1 illustrated in FIG. 21 includes a dummy capacitance element 22d connected to the second electrode of the pixel circuit 90, and a reference transistor TREF and an initialization transistor TINI as means for varying the potential of the first dummy electrode of the dummy capacitance element 22d.

The potential of the second electrode can be varied by operating the reference transistor TREF and the initialization transistor TINI as in the pixel circuit 90. Although a configuration in which the organic EL element 24 is used as the dummy capacitance element 22d is illustrated in the example in FIG. 21, any of the configurations described above can be used as the configuration of the dummy capacitance element 22d. This also applies to the configuration of the dummy capacitance element 22d in the following modifications.

Although a minimum configuration needed to change the potential of the second electrode is illustrated in FIG. 21, the dummy pixel circuit 90d1 may include at least one of the data signal line SIG, the writing transistor TWS, and the drive transistor TD present in the pixel circuit 90.

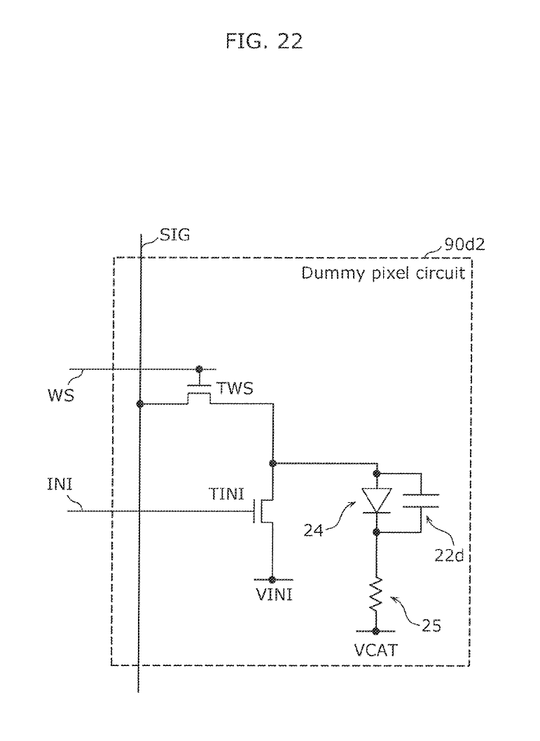

Unlike in FIG. 21, the dummy pixel circuit 90d2 illustrated in FIG. 22 has a configuration including the data signal line SIG and the writing transistor TWS, rather than the reference power supply line VREF and the reference transistor TREF.

The potential of the second electrode is varied by varying the potential of the first dummy electrode of the dummy capacitance element 22d by the data signal line SIG and the initialization power supply line VINI. Although a minimum configuration needed to change the potential of the second electrode is illustrated in FIG. 22, the dummy pixel circuit 90d2 may include at least one of the data signal line SIG, the writing transistor TWS, and the drive transistor TD present in the pixel circuit 90.

The dummy pixel circuit 90d3 illustrated in FIG. 23 is the same as the pixel circuit 90 except that the dummy pixel circuit 90d3 includes a switching transistor TZ and a dummy signal line Va, rather than the data signal line SIG, the writing transistor TWS, the reference power supply line VREF, and the reference transistor TREF. In such a configuration, for example, a voltage substantially equal to the reference voltage is applied to the dummy signal line Va. Furthermore, by controlling the switching transistor TZ by the control signal line SW, the voltage applied to the dummy signal line Va can be applied to the first dummy electrode of the dummy capacitance element 22d. Subsequently, by performing the initialization control using the initialization transistor TINI, the potential of the second electrode of the dummy capacitance element 22d can be varied as in the dummy pixel circuits described above.

In the dummy pixel circuit 90d3 illustrated in FIG. 23, the voltage applied to the dummy signal line Va may be applied using the power supply for a voltage applied to the pixel circuit 90, or may be applied by another power supply. In the case where another power supply is used, the relation among the current, voltage, and light emission amount of the organic EL element 24 can be obtained by applying a voltage between the dummy signal line Va and the organic EL element 24. Furthermore, the relation among the current, voltage, and light emission amount of the organic EL element 24 having light-emitting colors of RGB or RGBW can be obtained by separately disposing the dummy signal line Va for each of the dummy pixel circuit 90d3 having light-emitting colors of RGB or RGBW.

The pixel circuit and the dummy pixel circuit can have any other configuration than the configurations described above. For example, the pixel circuit 90 may have a circuit configuration in which a switching transistor is further interposed between the anode power supply line VCC and the drive transistor TD. The pixel circuit and the dummy pixel circuit do not need to include the reference transistor TREF, the reference signal line REF, and the reference power supply line VREF. For example, the pixel circuit and the dummy pixel circuit including only two transistors, i.e., the writing transistor TWS and the drive transistor TD can be implemented. In such a pixel circuit and the like, the signal voltage applied to the data signal line can be varied, and the potential of the second electrode can be varied by the signal voltage.

### Embodiment 2

A display device according to Embodiment 2 will be described. The display device according to the present embodiment has a configuration to reduce a variation in potential of the initialization power supply line VINI in the display device 9 according to Embodiment 1. The configuration of the initialization power supply line VINI in the display device 9 according to the present embodiment will now be described below.

### [2-1. Configuration of Initialization Power Supply Line]

The display device 9 according to Embodiment 1 has a configuration in which each row of the pixel circuits 90 arranged into the matrix is scanned. In such a configuration, in the case where a so-called one-dimensional wiring disposed in a linear form for each row is used as the initialization power supply line VINI, the discharge of EL capacitance elements 22 in the pixel circuits 90 present in one row concentrates into a single wiring. For this reason, the potential increases, in particular, in a position distant from an electricity feeder disposed near the end of the display panel 10, that is, in a portion of the wiring located in the central portion of the display panel 10. This phenomenon will be described with reference to the drawing.

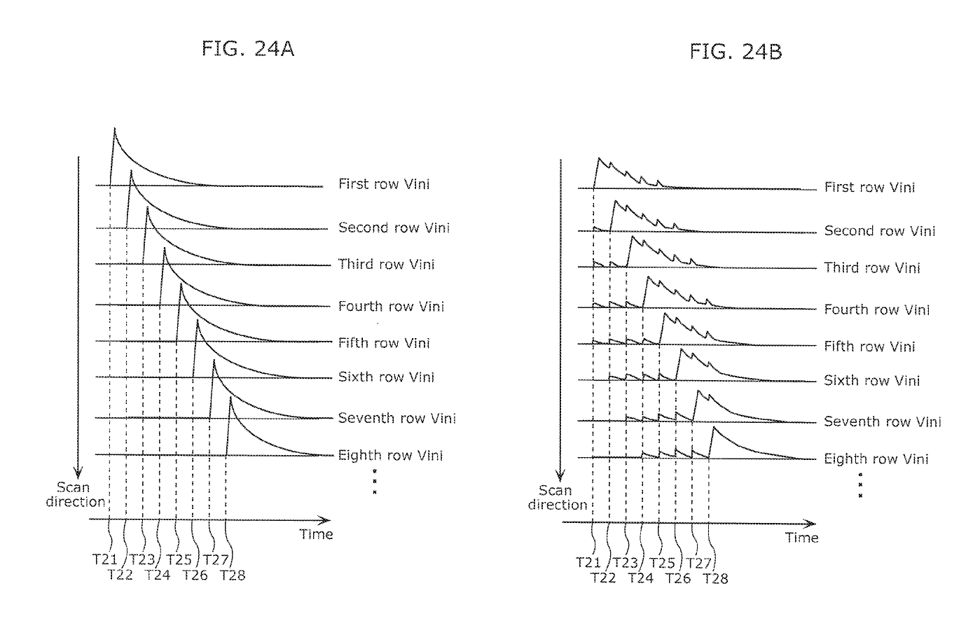

FIG. 24A is a schematic graph illustrating waveforms of the potentials of the initialization power supply lines VINI in rows in the display device 9 according to Embodiment 1. FIG. 24A illustrates the potentials of the initialization power supply lines VINI in the central portion of the display panel 10 in the case where a one-dimensional wiring is used as the initialization power supply line VINI. The points of time T21 to T28 illustrated in FIG. 24A are the start points of time (point of time T2 in FIG. 4) of the initialization control in the pixel circuits 90 in first to eighth rows, respectively.

As illustrated in FIG. 24A, the potential of the initialization power supply line VINI in each row increases. Such a variation in potential of the initialization power supply line VINI leads to variations in potentials of the first electrode and the second electrode of the organic EL element 24, which may cause the uneven luminance of the display device 9.

In the present embodiment, a two-dimensional wiring is used as the initialization power supply line VINI to provide a configuration in which the variation in potential of the initialization power supply line VINI is reduced. In other words, in the present embodiment, a wiring disposed in the horizontal scan direction and the vertical scan direction and formed into a lattice is used as the initialization power supply line VINI. A variation in potential in such an initialization power supply line VINI will be described with reference to the drawing.

FIG. 24B is a schematic graph illustrating waveforms of potentials of the initialization power supply lines VINI in rows in the display device according to the present embodiment. FIG. 24B illustrates the potentials of the initialization power supply lines VINI in the central portion of the display panel in the case where a two-dimensional wiring is used as the initialization power supply line VINI. The points of time T21 to T28 illustrated in FIG. 24B are the start points of time (point of time T2 in FIG. 4) of the initialization control in the pixel circuits 90 in first to eighth rows, respectively.

As illustrated in FIG. 24B, the initialization power supply line VINI formed of the two-dimensional wiring according to the present embodiment has a smaller variation in potential than that of the initialization power supply line VINI formed of a one-dimensional wiring illustrated in FIG. 24A. Note that the number of variations in potential in one frame period increases because the variation in potential is conducted between rows in the initialization power supply line VINI according to the present embodiment. Such a phenomenon will be described with reference to the drawing.

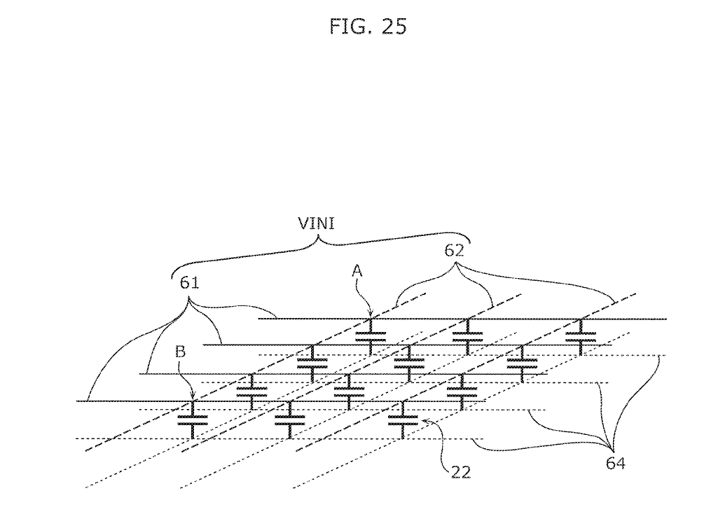

FIG. 25 is a schematic wiring diagram illustrating a configuration of the initialization power supply line VINI according to the present embodiment. FIG. 25 illustrates the horizontal scan direction wiring 61 (solid line) and the vertical scan direction wiring 62 (bold dashed line) of the initialization power supply line VINI. FIG. 25 also illustrates the second electrode (cathode) of the organic EL element 24 as a wiring 64 represented by a short dashed line. Furthermore, FIG. 25 illustrates the EL capacitance element 22 of the organic EL element 24. In FIG. 25, the elements other than the EL capacitance element 22, which are connected between the initialization power supply line VINI and the second electrode of the organic EL element 24, are omitted.

As illustrated in FIG. 25, the display panel according to the present embodiment includes the initialization power supply line VINI which feeds an initialization voltage to the pixel circuits 90. The initialization power supply line VINI includes the horizontal scan direction wiring 61 extending in the horizontal scan direction of the pixel circuits 90 and the vertical scan direction wiring 62 extending in the vertical scan direction of the pixel circuits 90.

As illustrated in FIG. 25, in the present embodiment, for example, a variation in potential of the initialization power supply line VINI at the point B of the horizontal scan direction wiring 61 is conducted through the vertical scan direction wiring 62 to the point A of another horizontal scan direction wiring 61. As a result, as illustrated in FIG. 24B, the initialization power supply lines VINI in the rows vary several times in one frame period.

As described above, the vertical scan direction wiring 62 disposed in the initialization power supply line VINI can reduce the amount of variation in potential of the initialization power supply line VINI while increasing the number of variations.

In addition, as illustrated in FIG. 25, the variation in potential of the initialization power supply line VINI is conducted through the EL capacitance element 22 to the second electrode of the organic EL element 24 (wiring 64 in FIG. 25), which causes the uneven luminance of the display device.

Accordingly, in the present embodiment, the vertical scan direction wiring 62 of the initialization power supply line VINI is configured to have a larger resistance per unit length than that of the horizontal scan direction wiring 61. Such a configuration can reduce the influences of the increased number of variations in potential while reducing the amount of variation in potential of the initialization power supply line VINI.

The resistance values of the horizontal scan direction wiring 61 and the vertical scan direction wiring 62 may be appropriately optimized according to the size of the display panel, for example. The resistance values may be appropriately adjusted according to the wiring material and the wiring width, for example.

### Embodiment 3

A display device according to Embodiment 3 will be described. The display device according to the present embodiment has a configuration which can reduce the leakage current in the pixel circuit 90, which may cause the uneven luminance of the display device. The pixel circuit 90 according to the present embodiment will now be described below.

### [3-1. Leakage Current]

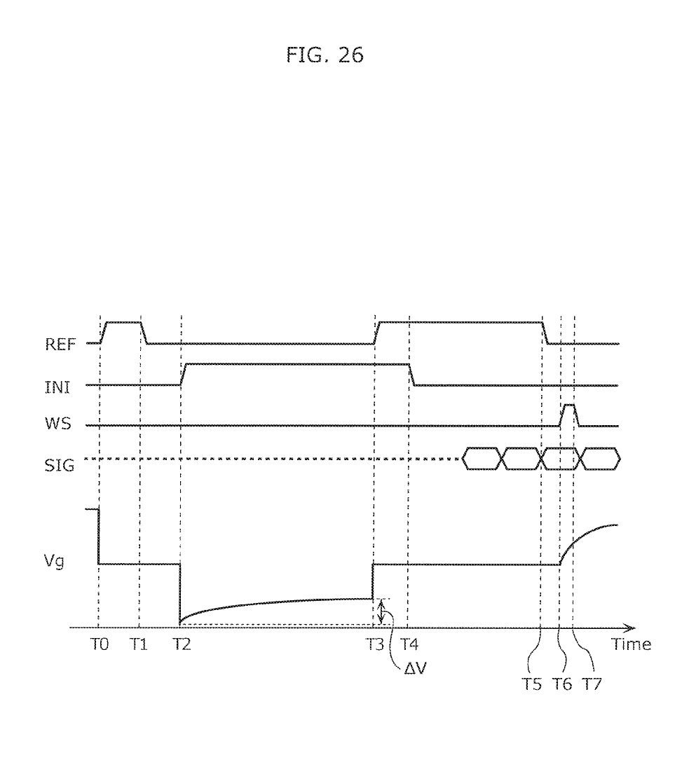

First, the leakage current in the pixel circuit 90 in the display device 9 according to Embodiment 1 will be described with reference to a drawing. FIG. 26 is a graph illustrating a waveform of the potential Vg of the gate electrode g of the drive transistor TD in the pixel circuit 90 according to Embodiment 1. FIG. 26 also illustrates the waveforms of signals input to the reference signal line REF, the initialization signal line INI, the writing signal line WS, and the data signal line SIG. Note that the waveforms of the signals are the same as those illustrated in FIG. 4.

As illustrated in FIG. 26, the initialization control is performed at the point of time T2, and the potential of the source electrode s of the drive transistor TD reduces to about −3 V. The potential Vg of gate electrode g is also reduced through the capacitance element 20. As a result, the potential Vg of the gate electrode g becomes lower than the off potential of the writing transistor TWS and the reference transistor TREF, and the leakage current is generated in these transistors. Accompanied by this, the potential Vg of the gate electrode g increases. ΔV illustrated in FIG. 26 represents the increased amount of the potential accompanied by the leakage current.

The influences of the leakage current in the writing transistor TWS and the reference transistor TREF over the uneven luminance of the display device will now be described.

First, the case where the leakage current is generated in the writing transistor TWS will be described. In this case, because the current flows from the data signal line SIG, which is connected to the writing transistor TWS, to the capacitance element 20, the voltage of the data signal reduces. In other words, the luminance of the organic EL element 24 reduces. Here, in the pixel circuits 90 in the uneven luminance occurring region (i.e., the region in which the luminance reduces) at a timing in which the data signal is written, a smaller number of pixel circuits 90 among the pixel circuits 90 is subjected to the initialization control than that of the pixel circuits 90 in other regions at the timing in which the data signal is written. For this reason, a reduced amount of the voltage of the data signal written in the pixel circuits 90 in the uneven luminance occurring region is smaller than those of the pixel circuits 90 in other regions. In other words, the leakage current in the writing transistor TWS results in the luminance of the uneven luminance occurring region higher than those in other regions. For this reason, the leakage current in the writing transistor TWS is barely considered as the cause of the above-mentioned uneven luminance of the display device.

Next, the case where the leakage current is generated in the reference transistor TREF will be described.

In this case, because the current flows from the reference power supply line VREF, which is connected to the reference transistor TREF, to the capacitance element 20, the voltage of the reference power supply line VREF, i.e., the reference voltage Vref reduces. Here, the current Ids flowing during a period of light emission of the organic EL element 24 depends on the reference voltage Vref, as represented by Expression (1):

$$\begin{matrix}[ Expression 1 ] & \\ Ids = \frac{1}{2} μ \frac{W}{L} {\{ ( Vsig - Vref ) \times \frac{Coled}{Cs + Coled} - Vth \}}^{2} , & ( 1 )\end{matrix}$$

where μ, W, and L represent the carrier mobility, the channel width, and the channel length in the channel layer of the drive transistor TD, respectively; Vsig represents the voltage of the data signal; Coled and Cs represent the capacitance of the EL capacitance element 22 and the capacitance of the capacitance element 20, respectively; and Vth represents the threshold voltage of the drive transistor TD.

As represented by Expression (1), a variation in reference voltage Vref results in a variation in current Ids flowing in the organic EL element 24. As described above, the reference voltage Vref may vary according to the amount of the leakage current in the reference transistor TREF. For this reason, the uneven luminance of the display device may be generated when the amount of variation in reference voltage Vref is varied among the pixel circuits 90.

Here, the period for which the leakage current flows from the reference power supply line VREF through the reference transistor TREF to the gate electrode g of the drive transistor TD of the pixel circuit 90 corresponds to the points of time T2 to T3 illustrated in FIG. 4 in one frame for a single pixel circuit 90.

Considering the entire display device 9, the proportion of the number of rows of the pixel circuits 90 in which the leakage current flows to the total number of rows is represented by an expression (T3−T2)/(one horizontal scan period). In the region of the display unit 2 other than the region 902a which becomes dark, the total sum of the leakage current to the pixel circuits 90 fed by the reference power supply line VREF approximately amounts to the value represented by an expression (T3−T2)/(one horizontal scan period)×(the number of pixel circuits disposed in one row)×(leakage current per pixel circuit). In the region 902a, however, the sum of the leakage current from the reference power supply lines VREF during writing of the data signal is smaller than the value represented by an expression (T3−T2)/(one horizontal scan period)×(the number of pixel circuits disposed in one row)×(leakage current per pixel circuit) because the number of rows of the pixel circuits 90 subjected to the initialization control is smaller.

As a result, the reference voltage Vref during the writing of the region 902a becomes higher than the reference voltage Vref in the display region Pa other than the region 902a. Accordingly, the current Ids reduces as represented by Expression (1), and therefore the luminance in the region 902a is reduced compared to the luminance of the display region Pa other than the region 902a.

Because the leakage current in the reference transistor TREF may cause the uneven luminance of the display device as described above, the pixel circuit 90 according to the present embodiment reduces the leakage current in the reference transistor TREF.

### [3-2. Configuration of Pixel Circuit]

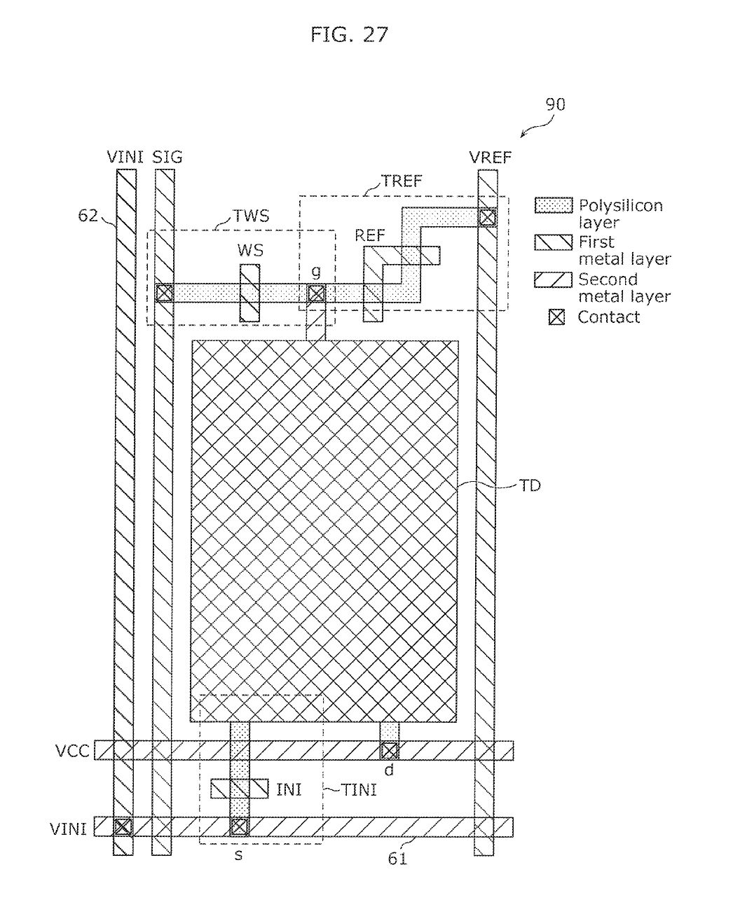

The configuration of the pixel circuit 90 according to the present embodiment will now be described with reference to a drawing. FIG. 27 is a diagram illustrating a wiring layout of the pixel circuit 90 according to the present embodiment. FIG. 27 illustrates the layout of the pixel circuit 90 in the display panel 10 in a plan view.

As illustrated in FIG. 27, the initialization power supply line VINI, the anode power supply line VCC, and the reference power supply line VREF are disposed, and the initialization transistor TINI, the drive transistor TD, the writing transistor TWS, and the reference transistor TREF connected to the power supply lines of these lines are disposed. As illustrated in FIG. 27, the pixel circuit 90 further includes the drive transistor TD, the reference power supply line VREF to which a reference voltage is applied, the reference transistor TREF connected between the reference power supply line VREF and the gate electrode g of the drive transistor TD, the data signal line SIG to which a voltage corresponding to the current fed to the organic EL element 24 is applied, and the writing transistor TWS connected between the data signal line SIG and the gate electrode g of the drive transistor TD. Note that the details of the capacitance element 20 and drive transistor TD of the pixel circuit 90 are omitted in the wiring layout for simplified illustration.

To reduce the leakage current in the reference transistor TREF of the pixel circuit 90 as illustrated in FIG. 27, the length of the lightly doped drain (LDD) of the reference transistor TREF is larger than that of the writing transistor TWS in the present embodiment. Such a configuration can reduce the leakage current in the reference transistor TREF. Furthermore, in the present embodiment, as illustrated in FIG. 27, two places of the reference signal line REF of the reference transistor TREF overlay a semiconductor layer, which is made of a polysilicon layer. Here, the reference transistor TREF according to the present embodiment is a double gate type transistor because the reference signal line REF is a wiring which functions as the gate electrode of the reference transistor TREF. Moreover, the reference transistor TREF has a larger number of gates than that in the writing transistor TWS of a single gate type. For these reasons, the reference transistor TREF can reduce the leakage current because the current can be blocked by the two gates thereof.

As illustrated in FIG. 27, the reference transistor TREF includes the two gates, and a semiconductor layer (polysilicon layer in FIG. 27) which forms a channel layer. In a plan view of the semiconductor layer, the semiconductor layer disposed between the two gates has an L shape. Such a configuration can increase the LDD length between the two gates.

As described above, the potential of the gate electrode g of the drive transistor TD reduces during the initialization control of the pixel circuit 90. For this reason, the source electrode and the drain electrode in the reference transistor TREF are reversed between the period of light emission of the organic EL element 24 and the period of the initialization control in the pixel circuit 90. As illustrated in FIG. 27, the increased LDD length between the two gates of the reference transistor TREF can reduce the leakage current irrespective of whether the source electrode and the drain electrode are reversed to either polarity.

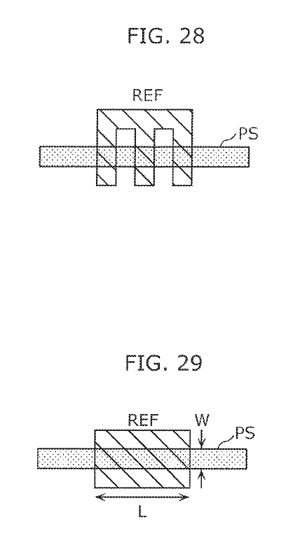

In the pixel circuit 90, the reference transistor TREF may include three or more gates. Such a reference transistor TREF will be described with reference to a drawing. FIG. 28 is a schematic view illustrating an outline of the shape of the electrode of the reference transistor TREF according to the present embodiment.

FIG. 28 illustrates the shape of the electrode of the semiconductor layer PS in a plan view.

As illustrated in FIG. 28, a triple gate type transistor can be achieved by the semiconductor layer PS overlaid with the reference signal line REF at three places. Such a configuration can further reduce the leakage current in the reference transistor TREF.

Moreover, in the pixel circuit 90, the reference transistor TREF may have a smaller ratio of the channel width to the channel length than that in the writing transistor TWS. Such a reference transistor TREF will be described with reference to a drawing. FIG. 29 is a schematic view illustrating an outline of the shape of the electrode of the reference transistor TREF according to the present embodiment. FIG. 29 illustrates the shape of the electrode of the semiconductor layer PS in a plan view.

The ratio W/L of the channel width W to the channel length L can be reduced by decreasing the channel width W and increasing the channel length L in the reference transistor TREF illustrated in FIG. 29. As described above, the leakage current in the reference transistor TREF can be reduced by reducing the ratio of the channel width to the channel length in the reference transistor TREF.

As described above, in the present embodiment, the uneven luminance of the display device can be reduced by reducing the leakage current in the reference transistor TREF.

### OTHER EMBODIMENTS

Although the display devices according to the present disclosure have been described based on the embodiments, these embodiments should not be construed as limitations to the display devices according to the present disclosure. Other embodiments achieved by combinations of any components in these embodiments, modifications obtained from a variety of modifications of these embodiments conceived by persons skilled in the art without departing from the gist of the present disclosure, and a variety of apparatuses and devices including the display devices according to the present embodiment are also included in the present disclosure.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is useful for flat panel displays including organic EL elements, for example.

1. A display device comprising:
a display panel; and
a control circuit which controls the display panel,
wherein the display panel includes:
pixel circuits arranged into a matrix in a display region of the display panel, and
one or more dummy pixel circuits disposed external to the display region,
each of the pixel circuits includes:
an organic EL element having a first electrode and a second electrode,
a capacitance element which retains voltage, and
a drive transistor which is connected to the first electrode of the organic electroluminescent (EL) element and feeds a current corresponding to the voltage retained in the capacitance element to the organic EL element,
each of the one or more dummy pixel circuits includes
a dummy capacitance element having a first dummy electrode, and a second dummy electrode shared with the second electrode of the organic EL element, and
the control circuit performs at least one of initialization controls within a period for which threshold compensation control to compensate for a threshold voltage of the drive transistor is performed on each of the pixel circuits, the initialization controls being initialization control to initialize a potential of the first electrode of the organic EL element in at least one different pixel circuit among the pixel circuits and dummy initialization control to initialize a potential of the first dummy electrode of the dummy capacitance element.

2. The display device according to claim 1,
wherein the control circuit scans target pixel circuits for light emission in a vertical scan direction among the pixel circuits arranged into the matrix, and
the one or more dummy pixel circuits are disposed in the vertical scan direction with respect to the display region.

3. The display device according to claim 2,
wherein the one or more dummy pixel circuits are disposed in a region adjacent to the pixel circuits in a last scanned row among the pixel circuits arranged into the matrix.

4. The display device according to claim 2,
wherein the one or more dummy pixel circuits are disposed on both sides of the display region in the vertical scan direction.

5. The display device according to claim 2,
wherein among the pixel circuits arranged into the matrix, the one or more dummy pixel circuits are not disposed in the vertical scan direction of the pixel circuit located at at least one of ends of the last scanned row.

6. The display device according to claim 2,
wherein the one or more dummy pixel circuits are disposed in multiple regions aligned in a horizontal scan direction of the pixel circuits.

7. The display device according to claim 1,
wherein the one or more dummy pixel circuits are arranged into a matrix, and
the number of rows of the one or more dummy pixel circuits disposed is equal to the number of horizontal scan periods contained in a vertical blanking interval in one frame period of the display panel.

8. The display device according to claim 1,
wherein the one or more dummy pixel circuits are arranged into a matrix, and
the number of dummy pixel circuits in each row of the one or more dummy pixel circuits arranged into the matrix decreases with distance from the display region.

9. The display device according to claim 1,
wherein the one or more dummy pixel circuits are arranged into a matrix, and
the number of rows of the one or more dummy pixel circuits disposed is smaller than the number of horizontal scan periods contained in a blanking interval in one frame period of the display panel.

10. The display device according to claim 1,
wherein the display panel includes an initialization power supply line which feeds an initialization voltage to the pixel circuits,
the initialization power supply line includes a horizontal scan direction wiring extending in a horizontal scan direction of the pixel circuits, and a vertical scan direction wiring extending in a vertical scan direction of the pixel circuits, and
the vertical scan direction wiring has a larger resistance per unit length than a resistance per unit length of the horizontal scan direction wiring.

11. The display device according to claim 1,
wherein the pixel circuit further includes:
a reference power supply line to which a reference voltage is applied;
a reference transistor connected between the reference power supply line and a gate electrode of the drive transistor;
a data signal line to which a voltage corresponding to a current fed to the organic EL element is applied; and
a writing transistor connected between the data signal line and the gate electrode of the drive transistor.

12. The display device according to claim 11,
wherein the reference transistor has a lightly doped drain (LDD) having a larger length than a length of the writing transistor.

13. The display device according to claim 11,
wherein a ratio of a channel width to a channel length in the reference transistor is smaller than a ratio of a channel width to a channel length in the writing transistor.

14. The display device according to claim 11,
wherein the reference transistor has a larger number of gates than the number of gates in the writing transistor.

15. The display device according to claim 11,
wherein the reference transistor includes two gates, and a semiconductor layer which forms a channel layer, and
in a plan view of the semiconductor layer, the semiconductor layer disposed between the two gates has an L shape.
